(19) United States
(12) Patent Application Publication
(10) Pub. No.: US 2008/0107182 A1
(43) Pub. Date: May 8, 2008

(54) Motion vector detecting method, motion vector detecting device, and imaging system

(76) Inventor: Yasuharu Tanaka, Osaka (JP)

Correspondence Address: MCDERMOTT WILL & EMERY LLP, 600 13TH STREET, NW, WASHINGTON, DC, 20005-3096, US

(21) Appl. No.: 11/979,482

(22) Filed: Nov. 5, 2007

(30) Foreign Application Priority Data
Nov. 8, 2006 (JP) 2006-303264

(51) Int. Cl. H04N 7/12

(52) U.S. Cl. 375/240.16; 375/E07.03

(57) ABSTRACT

A motion vector detecting method includes a target image reading step of reading a target image from a target image storing section, a reference image reading step of reading image data having the same size as that of the target image and, in addition, at least one or more packing units of extra image data from a reference image storing section, a correlation degree calculating step of calculating a degree of correlation between the target image and a plurality of reference blocks, where each reference block is a block of image data having the same size of that of the target image within the image data read out in the reference image reading step, and the reference blocks have locations different from each other.

### CROSS REFERENCE TO RELATED APPLICATIONS

This Non-provisional application claims priority under 35 U.S.C. §119(a) on Patent Application No. 2006-303264 filed in Japan on Nov. 8, 2006, the entire contents of which are hereby incorporated by reference.

### BACKGROUND OF THE INVENTION

1. Field of the Invention

The present invention relates to a motion vector detecting method, a motion vector detecting device, and an imaging system for use in motion compensation predictive encoding in moving image compression encoding.

2. Description of the Related Art

In recent years, there has been a rapid progress in practical moving image compression encoding techniques, such as MPEG (Moving Picture Experts Group) having highly efficient encoding ability and the like, which have come into widespread use in camcorders, mobile telephones, and the like. In moving image compression encoding techniques, such as MPEG and the like, motion compensation prediction is used in which only a displacement of a subject and difference data between images are encoded so as to efficiently compress image data. When the motion compensation prediction is performed, it is necessary to detect a motion vector indicating a displacement of a subject.

To detect such a motion vector, a block matching method is widely used. In a motion vector detecting method employing the block matching method, image data of a block composed of a predetermined number of pixels in a current image which are to be encoded (hereinafter referred to as a target image or a target block) is compared with a region which is located in the vicinity of the target block in the same space in an image preceding the current image and is larger than the target block (hereinafter referred to as a reference region) so as to obtain the degree of correlation between the target image and the reference image by calculating a predetermined evaluation function. Thereafter, a location of a reference block (a block which is in the reference region and has the same size as that of the target block) which matches the target block best (correlation is strong) is obtained, a distance and a direction between the location of the reference block and the location of the target block are detected as a motion vector.

As a method for detecting a reference block having strong correlation, for example, there is a well-known method in which correlation coefficients of upper, lower, left, and right locations are obtained with reference to a predetermined search start location (referred to as a reference point) in a reference region, the reference point is shifted to a location where correlation is highest, and the search location is shifted so that a highest level of correlation is obtained while performing correlation calculation with respect to a direction for which a correlation coefficient has not yet been calculated (One-at-a-Time method).

In the block matching method, the motion vector detection requires a large processing amount, so that it takes a long time to complete the process. Therefore, various attempts have been made to speed up the process. For example, a motion vector detecting device has been disclosed in which a plurality of devices for calculating the evaluation function (e.g., difference accumulating devices) are prepared so as to perform parallel processing, thereby speeding up the process (see, for example, Japanese Unexamined Patent Application Publication No. 2006-13873).

Generally, in many data processing devices, when data is transferred and is read from and written to a storage device, a technique of increasing the processing speed by packing a P (P is any natural number) pieces of data is employed. Therefore, also in the above-described motion vector detecting device, it is contemplated that the target image and the reference image are packed so as to increase the processing speed.

However, a boundary between reference blocks does not necessarily coincide with a boundary between pieces of packed data. Therefore, when a plurality of reference blocks are read from a storage device which stores data of a reference region while shifting the locations thereof, the same data may be redundantly read out, likely leading to a significant deterioration in read efficiency.

### SUMMARY OF THE INVENTION

The present invention has been achieved in view of the above-described problems. An object of the present invention is to provide a technique of detecting a motion vector without redundantly reading data of a reference region when the data of the reference region is packed and stored in a memory device.

To achieve the object, according to an embodiment of the present invention, a method is provided for detecting a motion vector in units of a block using a rectangular target image packed in units of a first pixel number and stored in a target image storing section and a rectangular reference image packed in units of a second pixel number and stored in a reference image storing section when moving image compression encoding is performed. The method comprises a target image reading step of reading the target image from the target image storing section, a reference image reading step of reading image data having the same size as that of the target image and, in addition, at least one or more reference image packing units of extra image data from the reference image storing section, and a correlation degree calculating step of calculating a degree of correlation between the target image and each of a plurality of reference blocks, wherein each reference block is a block of image data having the same size of that of the target image within the image data read out in the reference image reading step, and the reference blocks have locations different from each other.

### BRIEF DESCRIPTION OF THE DRAWINGS

FIG. 1 is a block diagram showing a motion vector detecting device 100 according to Embodiment 1 of the present invention.

FIG. 2 is a diagram showing a size of a target image stored in a target image storing section.

FIG. 3 is a diagram showing a portion of a reference image.

FIG. 4 is a diagram showing a portion of a reference image.

FIG. 5 is a diagram showing data which is transferred to SAD calculating sections 108-1 to 108-5.

FIG. 6 is a flowchart of a process performed in the motion vector detecting device 100.

FIG. 7 is a diagram showing changing states of data in a search result storing section 109.

FIG. 8 is a diagram showing a state of a searched point storing section 110 at time to.

FIG. 9 is a diagram showing a reference image region required for a search with respect to a motion vector point (4, 0).

FIG. 10 is a diagram showing timing of reading a target image and a reference image, temporarily accumulation of read data, and supply of data to an SAD calculating section 108 when calculation is performed with respect to a motion vector point (0, 0).

FIG. 11 is a diagram showing a state at time t1 of a searched point storing section 110.

FIG. 12 is a diagram showing a state at time t2 of the searched point storing section 110.

FIG. 13 is a diagram showing a state at time t3 of the searched point storing section 110.

FIG. 14 is a diagram showing a state at time t4 of the searched point storing section 110.

FIG. 15 is a diagram for describing the number of times of reading of a target image and a reference image when an SAD value is obtained point by point using the One-at-a-Time method.

FIG. 16 is a diagram for describing the number of times of reading of a target image and a reference image when an SAD value is obtained by the motion vector detecting device of Embodiment 1.

FIG. 17 is a diagram for describing points with respect to which a search is performed simultaneously when a search is not performed with respect to redundant search points.

FIG. 18 is a block diagram showing a motion vector detecting device 200 according to Embodiment 2.

FIG. 19 is a diagram for describing a search operation performed in the motion vector detecting device 200 of Embodiment 2.

FIG. 20 is a flowchart of a process performed in the motion vector detecting device 200 of Embodiment 2.

FIG. 21 is a diagram for describing a search operation when the value of a flag is previously confirmed.

FIG. 22 is a diagram showing a sub-sampled target image.

FIG. 23 is a diagram showing a sub-sampled reference image which is used in a search with respect to a motion vector point (0, 0).

FIG. 24 is a diagram showing a sub-sampled reference image which is used in a search with respect to a motion vector point (1, 0).

FIG. 25 is a diagram showing a sub-sampled reference image which is used in a search with respect to a motion vector point (2, 0).

FIG. 26 is a diagram showing a sub-sampled reference image which is used in a search with respect to a motion vector point (3, 0).

FIG. 27 is a diagram showing a sub-sampled reference image which is used in a search with respect to a motion vector point (4, 0).

FIG. 28 is a diagram showing a sub-sampled reference image which is used in a search with respect to a motion vector point (5, 0).

FIG. 29 is a diagram showing a sub-sampled reference image which is used in a search with respect to a motion vector point (6, 0).

FIG. 30 is a diagram showing a sub-sampled reference image which is used in a search with respect to a motion vector point (7, 0).

FIG. 31 is a diagram showing a sub-sampled reference image which is used in a search with respect to a motion vector point (8, 0).

FIG. 32 is a diagram for describing repacked image data.

FIG. 33 is a diagram showing a repacked target image.

FIG. 34 is a diagram for describing an order in which a reference image is read out when the x coordinate of a motion vector is an even number.

FIG. 35 is a diagram for describing an order in which a reference image is read out when the x coordinate of a motion vector is an odd number.

FIG. 36 is a diagram showing a configuration of an imaging system 400 according to Embodiment 4.

FIG. 37A is a diagram showing exemplary storage of pixels when P=4 and a target image storing section 102 comprises one storage means.

FIG. 37B is a diagram showing exemplary storage of pixels when P=2 and the target image storing section 102 comprises two storage means.

FIG. 37C is a diagram showing exemplary storage of pixels when P=1 and the target image storing section 102 comprises four storage means.

### DETAILED DESCRIPTION OF THE PREFERRED EMBODIMENTS

Hereinafter, embodiments of the present invention will be described with reference to the accompanying drawings. Like parts are indicated by like reference numerals throughout the specification and will not be repeatedly described.

### Embodiment 1 of the Invention

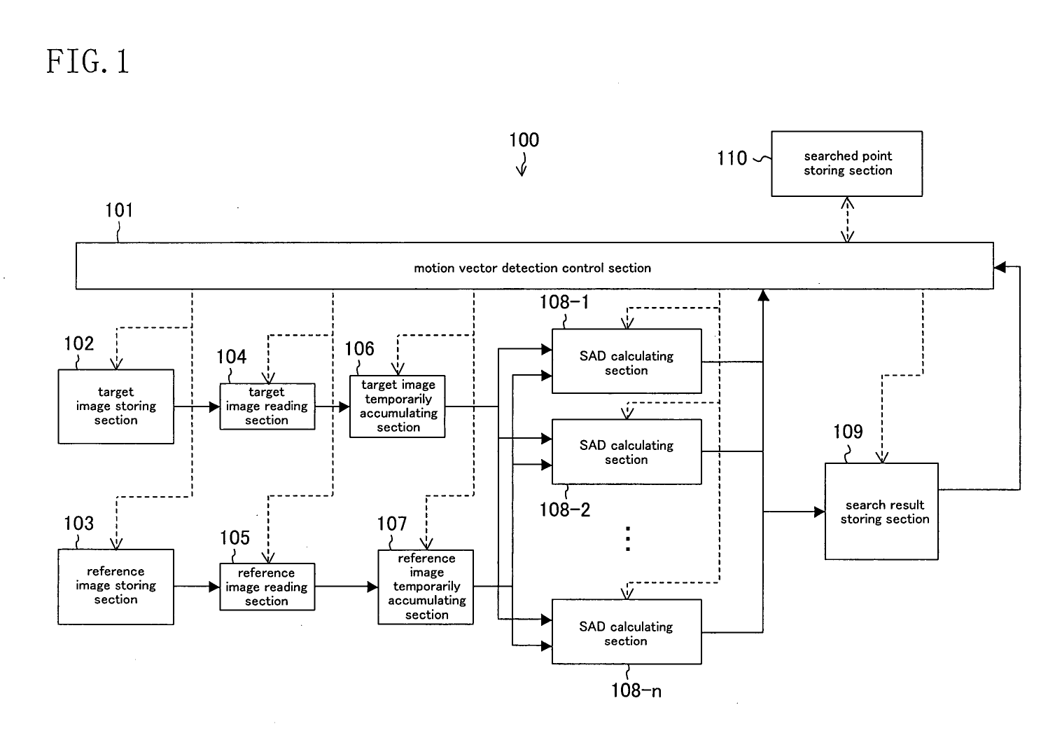

FIG. 1 is a block diagram showing a motion vector detecting device 100 according to Embodiment 1 of the present invention. The motion vector detecting device 100 is an example of a device which detects a motion vector indicating a displacement of a subject when motion compensation prediction is performed in, for example, a camcorder, a mobile telephone, or the like.

(Configuration of Motion Vector Detecting Device 100)

As shown in FIG. 1, the motion vector detecting device 100 comprises a motion vector detection control section 101, a target image storing section 102, a reference image storing section 103, a target image reading section 104, a reference image reading section 105, a target image temporarily accumulating section 106, a reference image temporarily accumulating section 107, a plurality of (n) SAD calculating sections 108-1 to 108-n, a search result storing section 109, and a searched point storing section 110. The SAD calculating sections 108-1 to 108-n are also collectively referred to as an SAD calculating section 108.

(Function of Each Component)

The motion vector detection control section 101 controls operations of the target image storing section 102, the reference image storing section 103, the target image reading section 104, reference image reading section 105, the target image temporarily accumulating section 106, the reference image temporarily accumulating section 107, and the SAD calculating section 108 as follows.

The target image storing section 102 stores image data to be encoded (referred to as a target image or a target block) as it is packed in units of a predetermined number of pixels (referred to as a first pixel number).

The reference image storing section 103 stores the whole or a part of image data (referred to as a reference image) of a region (referred to as a reference region) in an image preceding in time a current image, as it is packed in units of a predetermined number of pixels (referred to as a second pixel number), where the region is located in the vicinity of the same space location as that of a target block and is larger than the target block. A reference image is used so as to perform a search with respect to a motion vector of a target image and encoding (specifically, a difference between the target image and the reference image is encoded). The first pixel number and the second pixel number are both referred to as a packing data number.

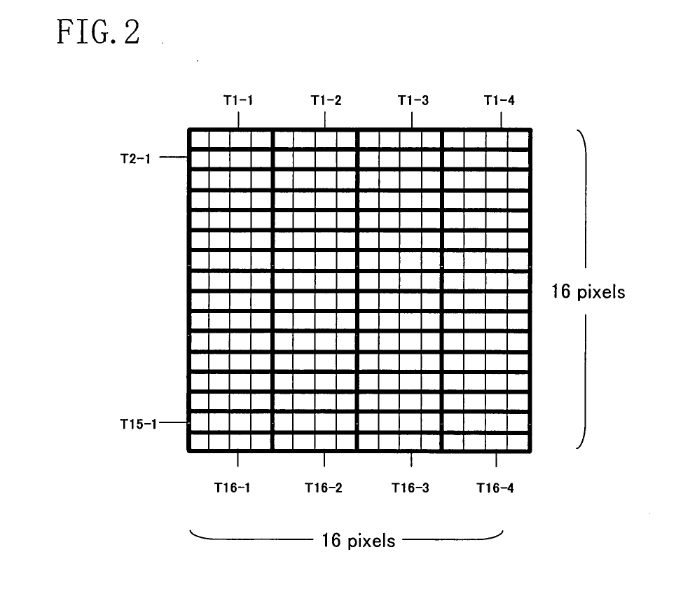

Note that it is assumed in this embodiment that a target image has a size (search size) of 16 pixels×16 pixels as shown in FIG. 2. It is also assumed that the first pixel number and the second pixel number are the same number of pixels P (P is a natural number). Hereinafter, a case where P=4 will be described.

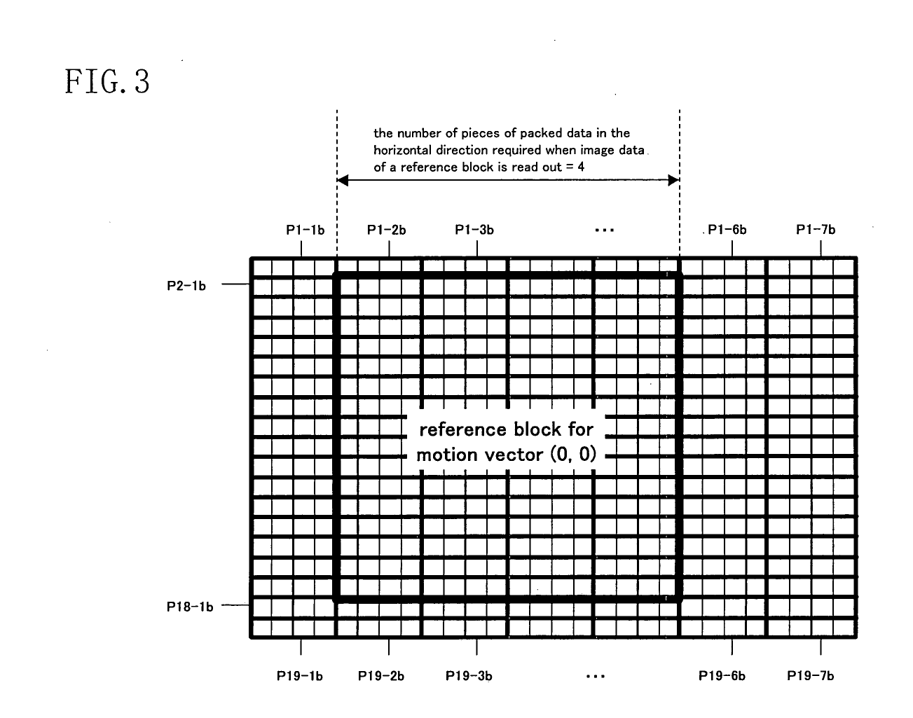

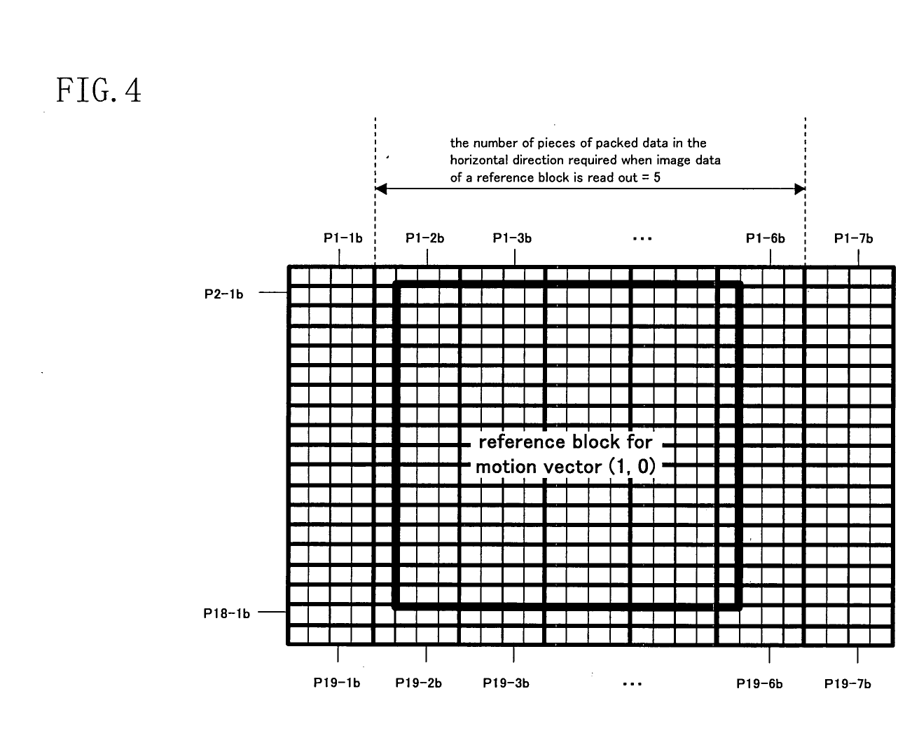

FIGS. 3 and 4 are diagrams showing a portion of a reference image. A region of 16 pixels×16 pixels which is enclosed by a thick line (referred to as a reference block) is a region which is used so as to calculate a degree of correlation between a target block and the reference block. The degree of correlation is evaluated by calculating the minimum of an evaluation function value which is the sum of the absolute values of pixel values of pixels constituting the target block and pixel values of pixels constituting the reference block (a value obtained from the evaluation function is referred to as an SAD value).

FIG. 3 is a diagram showing image data of a reference block for which a point (0, 0) is a search start point (reference point), and its vicinity. FIG. 4 is a diagram showing image data of a reference block for which a point (1, 0) is a search start point (reference point), and its vicinity. As used herein, the term “search with respect to a motion vector point (n, m)” refers to obtaining an SAD value with respect to a reference block where a point (n, m) is a reference point.

The number of pieces of packed data which are required when a search is performed with respect to a motion vector point (0, 0) can be seen from FIG. 3. Specifically, the number of pieces of packed data is 4 pieces of packed data (horizontal direction)×16 lines (vertical direction). This is the number of pieces of packed data to be read when 4 pieces of packed data (16 pixels) are read in the horizontal direction, and all image data thus read out is used for a search.

However, when the location of a reference image is shifted from this, a larger amount of image data needs to be read. For example, the number of pieces of packed data which are required when a search is performed with respect to a motion vector point (1, 0) is 5 pieces of packed data (horizontal direction)×16 lines (vertical direction) as shown in FIG. 4. Specifically, a reference image having a size of 5 pieces of packed data (horizontal direction)×16 lines (vertical direction), which is referred to as a reference read size, may be read out from the reference image storing section 103. In other words, the reference read size may be the size of a target image plus the size of the packing unit (at least one unit) of a reference image.

The target image reading section 104 reads out a target image stored in the target image storing section 102, which is required for SAD calculation, in units of the first pixel number (in this example, P pixels) in accordance with a control of the motion vector detection control section 101.

The reference image reading section 105 reads a reference image stored in the reference image storing section 103, which is required for SAD calculation, in units of the second pixel number (in this example, P pixels) and in an amount corresponding to the reference read size in accordance with a control of the motion vector detection control section 101.

The target image temporarily accumulating section 106 temporarily accumulates a target image read out by the target image reading section 104. More specifically, the target image temporarily accumulating section 106 has a buffer area having a capacity corresponding to a piece of packed data of a target image (i.e., P pixels of data) and performs an FIFO (First In First Out) operation. Note that the output of the target image temporarily accumulating section 106 is supplied to the SAD calculating sections 108-1 to 108-n in accordance with a control of the motion vector detection control section 101.

The reference image temporarily accumulating section 107 temporarily accumulates a reference image read out by the reference image reading section 105. More specifically, the reference image temporarily accumulating section 107 has a buffer area having a capacity corresponding to two pieces of packed data of a reference image (i.e., 2P pixels of data) and performs an FIFO operation.

The SAD calculating sections 108-1 to 108-n (in this embodiment, it is assumed that n=5) calculate an SAD value defined as described below, using a target image supplied from the target image temporarily accumulating section 106 and a reference image supplied from the reference image temporarily accumulating section 107.

The SAD value is defined by:
SAD=Σ|Ref(Mx+x,My+y)−Org(x,y)|
where Ref(Mx+x, My+y) indicates a pixel value at a pixel location (Mx+x, My+y) in a reference block located at a location (Mx, My) relative to a target block, and Org(x, y) indicates a pixel value at a pixel location (x, y) in the target block.

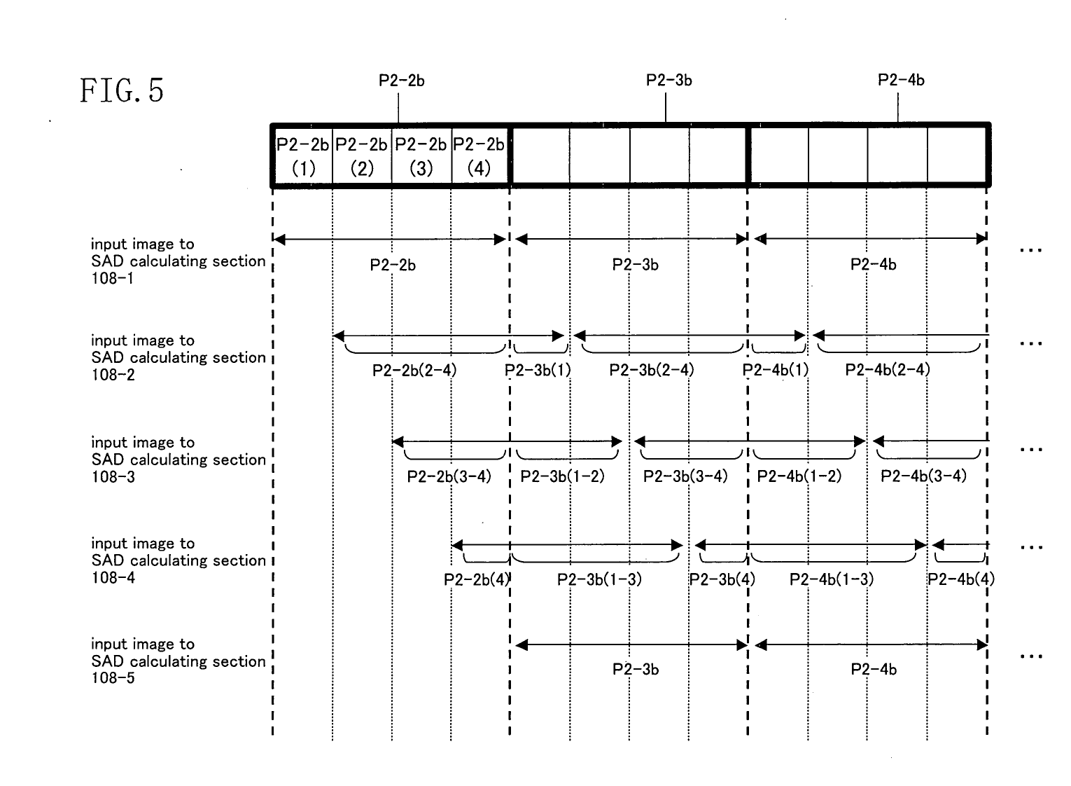

Also, the output of the reference image temporarily accumulating section 107 is supplied to the SAD calculating sections 108-1 to 108-n in accordance with a control of the motion vector detection control section 101. Specifically, two pieces of packed data (i.e., 8 pixels of data) accumulated in the reference image temporarily accumulating section 107 are decomposed into pixel units of data by the motion vector detection control section 101, which are in turn transferred to the SAD calculating sections 108-1 to 108-n. Specifically, assuming that 8 pixels of data accumulated in the reference image temporarily accumulating section 107 are represented by d1 to d8, 4 pixels of data d1 to d4 are transferred to the SAD calculating section 108-1, 4 pixels of data d2 to d5 are transferred to the SAD calculating section 108-2, 4 pixels of data d3 to d6 are transferred to the SAD calculating section 108-3, 4 pixels of data d4 to d7 are transferred to the SAD calculating section 108-4, and 4 pixels of data d5 to d8 are transferred to the SAD calculating section 108-5 (see FIG. 5).

Thereby, SAD values can be simultaneously obtained for 5 points which are shifted pixel by pixel in the horizontal direction. Specifically, an SAD calculating section which calculates the SAD value of a search point (0, 0) is the SAD calculating section 108-1. An SAD calculating section which calculates the SAD value of a search point (1, 0) is the SAD calculating section 108-2. An SAD calculating section which calculates the SAD value of a search point (4, 0) is the SAD calculating section 108-5. This is generalized as follow: search points whose SAD values can be simultaneously calculated are a point (4×P, Q), a point (4×P+1, Q), a point (4×P+2, Q), a point (4×P+3, Q), and a point (4×P+4, Q) (note that P and Q are integers).

The search result storing section 109 temporarily accumulates an SAD value which can be used in a motion vector search with respect to an image other than a target image.

The searched point storing section 110 stores a flag for determining, for example, whether or not a search has been performed (an SAD value has been obtained) with respect to each point in a reference image. In this embodiment, the flag is of two bits. Note that it is assumed that, if the value of the flag is “10b” (b indicates that the number is a binary number), the flag indicates that, although a search has already been completed, an SAD value is not stored in the search result storing section 109; if the value of the flag is “01b”, the flag indicates that a search has been completed and an SAD value is stored in the search result storing section 109; if the value of the flag is “00b”, the flag indicates that a search has not been performed.

(Operation of Motion Vector Detecting Device 100)

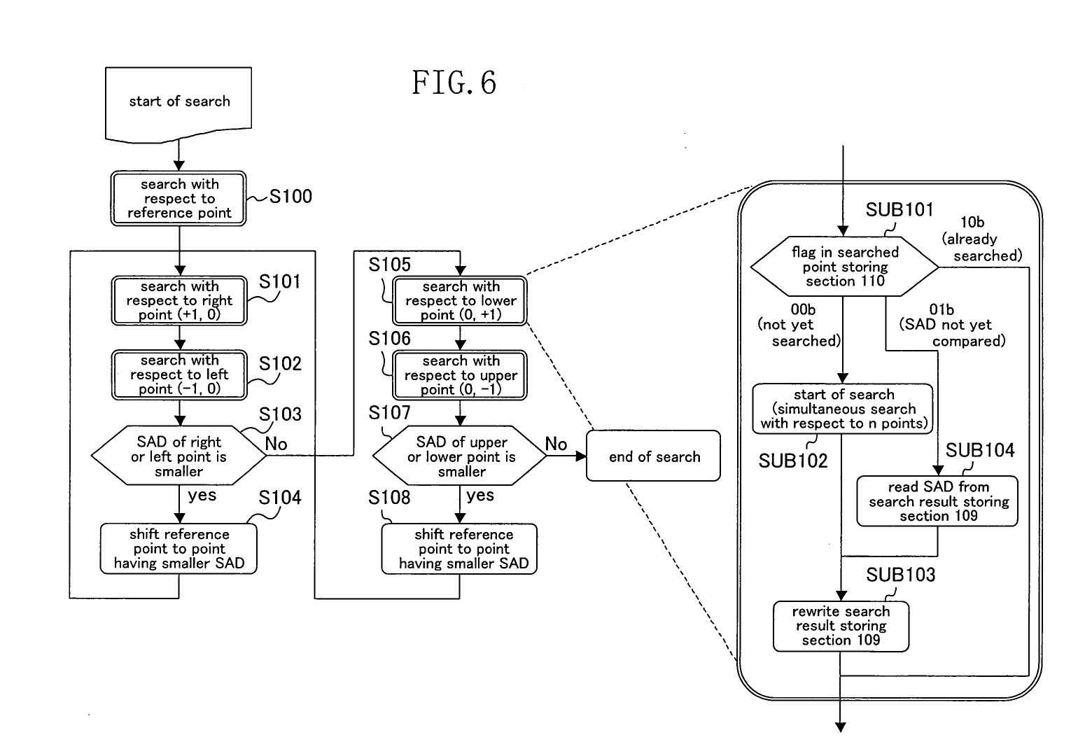

An operation of the motion vector detecting device 100 will be described, assuming a case where a minimum SAD value is searched for from a reference point (0, 0). FIG. 6 is a flowchart of a process performed in the motion vector detecting device 100. Note that, in steps of performing a search process (S100 to S102 and S105 and S106), sub-steps (SUB 101 to SUB 104) are performed for each search.

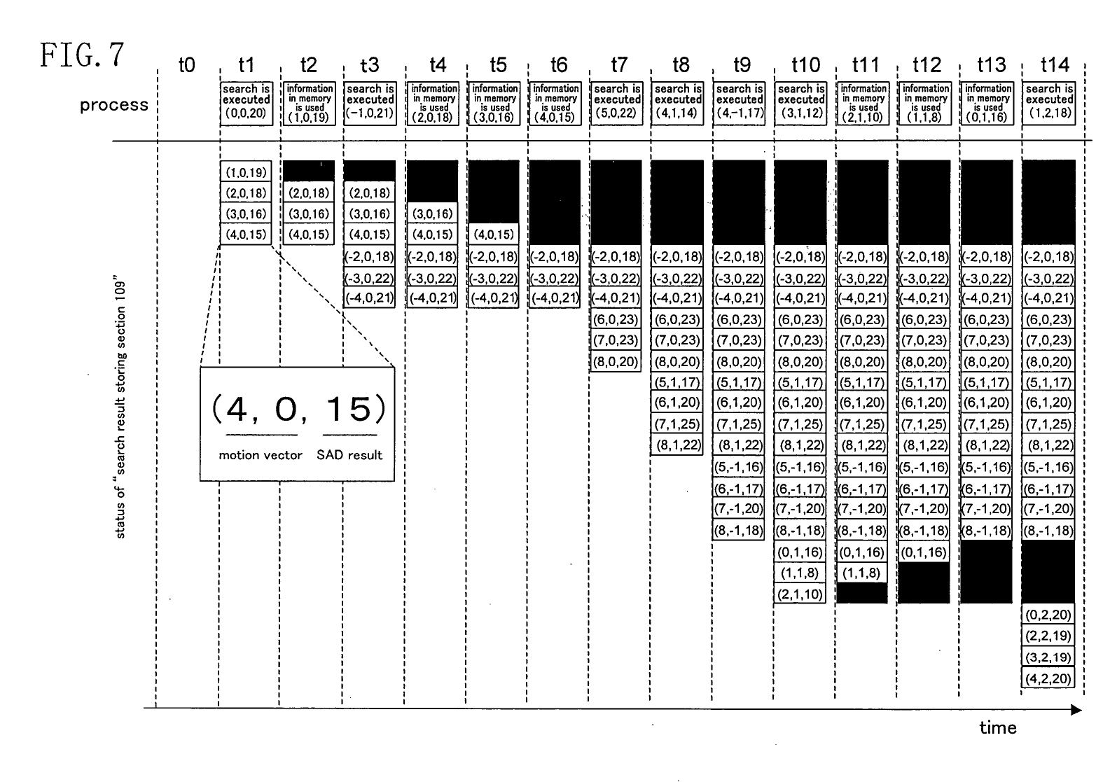

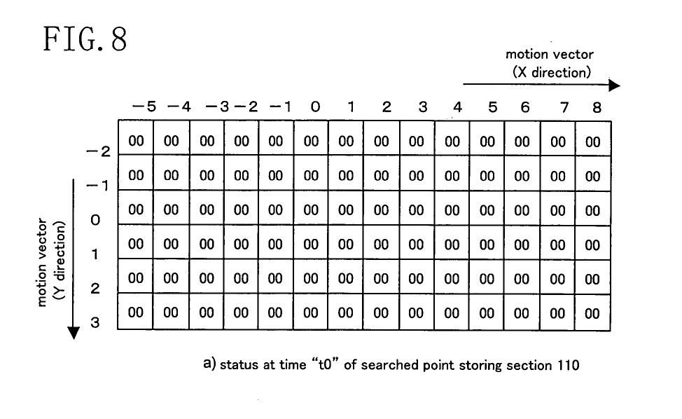

As a process during the start of the flow (initialization), the search result storing section 109 is cleared (time t0 in FIG. 7), and all flags in the searched point storing section 110 are reset to “00b” (see FIG. 8). Following completion of the initialization, processes are performed as described below.

As a first process, a search is performed with respect to the reference point (0, 0) (S100). For the search, the flow goes to the process of SUB101. In this process, initially, the motion vector detection control section 101 determines whether or not a search has been performed with respect to the reference point (0, 0), with reference to the status of a corresponding flag in the searched point storing section 110 (SUB101).

In this example, since the value of the flag is “00b” (see FIG. 8), the flow goes to SUB102. In SUB102, a search is actually performed with respect to the reference point (0, 0).

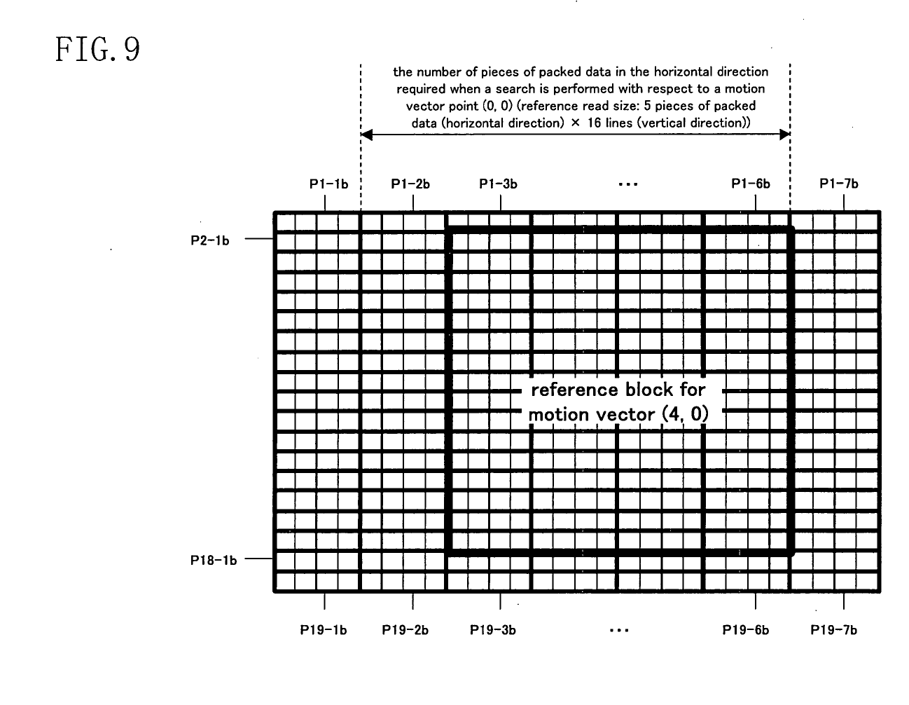

Initially, the motion vector detection control section 101 controls the reference image reading section 105 to read out a reference image. To perform a search with respect to a motion vector point (0, 0), packing data P2-2b to P17-5 (a total of 64 pieces of packed data) are required. In accordance with the reference read size, P2-2b to P17-6 (a total of 80 pieces of packed data) are read out. By this reading, a search can be performed with respect to a point (1, 0), a point (2,0), a point (3,0), and a point (4,0) as well as the reference point (0, 0). For reference, FIG. 9 shows a reference image region required for a search with respect to a motion vector point (4, 0).

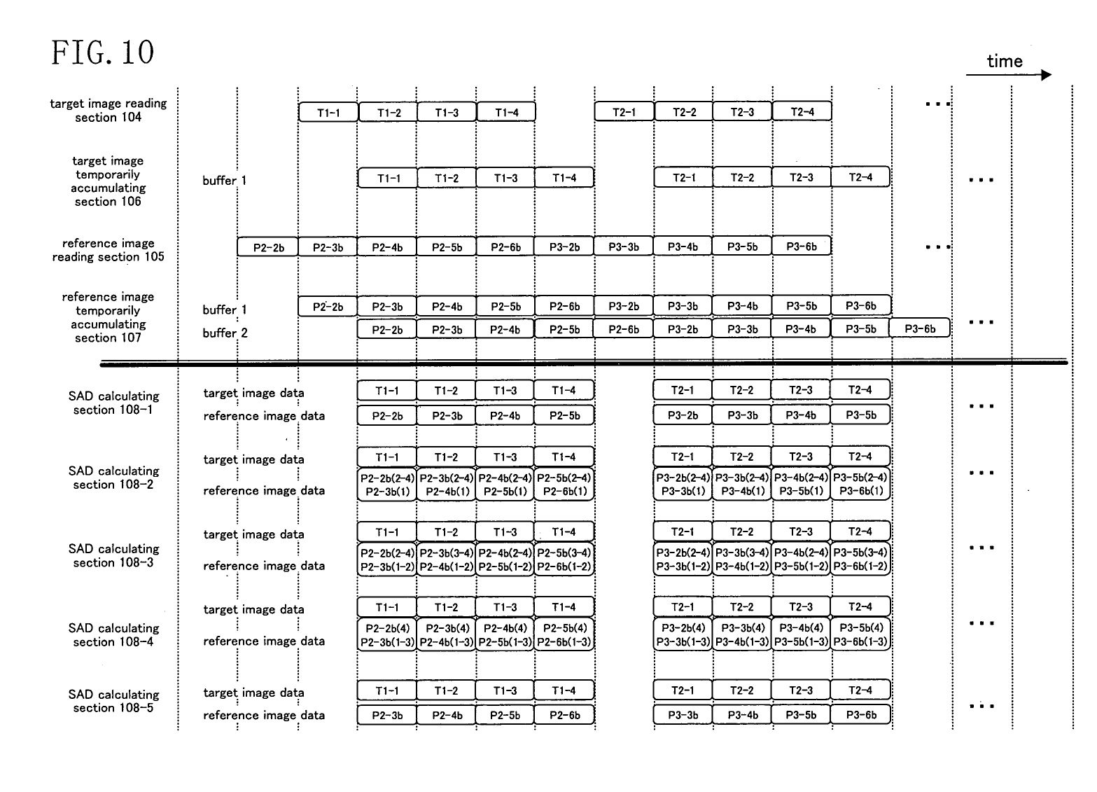

FIG. 10 shows reading of a target image and a reference image when the motion vector point (0, 0) is calculated (operations of the target image reading section 104 and the reference image reading section 105), temporary accumulation of read data (operations of the target image temporarily accumulating section 106 and the reference image temporarily accumulating section 107), and timing of data supply to the SAD calculating section 108.

Thus, when data is supplied to the SAD calculating section 108, the SAD calculating section 108 calculates an SAD value (performs a search). When the search is completed, the SAD value (e.g., “20”) of the reference point (0, 0) is returned to the motion vector detection control section 101.

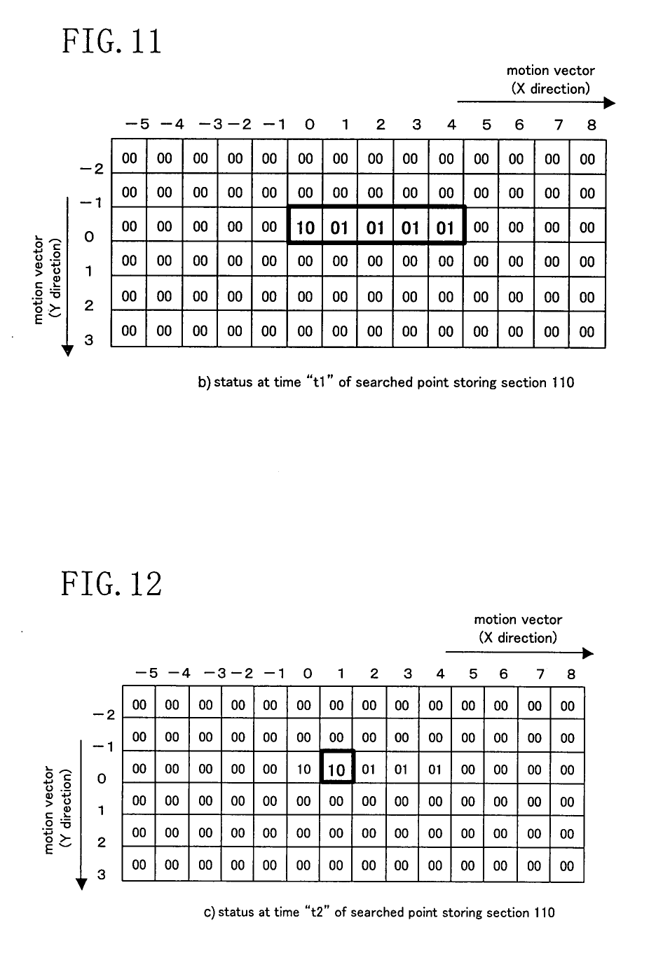

The motion vector detection control section 101 rewrites a flag in the searched point storing section 110 corresponding to the reference point (0, 0). Specifically, as shown in FIG. 11, the flag is rewritten to “10b”.

A search can be performed with respect to the search points (1, 0) to (4, 0) at the same time when a search is performed with respect to the reference point (0, 0). The calculated SAD values of the search points (1, 0) to (4, 0) with respect to which a search has been performed at the same time are stored into the search result storing section 109 (see t1 in FIG. 7). In other words, in this embodiment, a search can be performed simultaneously with respect to a total of five points. Flags in the searched point storing section 110 corresponding to the search points (1, 0) to (4, 0) whose SAD values are stored in the search result storing section 109 are rewritten to “01b”.

In the next process, a search is performed with respect to a point to the right of the reference point (S101). Since the reference point is now the point (0, 0), an SAD value of the search point (1, 0) is to be calculated. To calculate it, the motion vector detection control section 101 determines whether or not a search has been performed with respect to the search point (1, 0), with reference to the status of the flag in the searched point storing section 110 (SUB101).

For example, as shown in FIG. 11, if the value of the flag is “01b”, the search has already been completed and an SAD value is stored in the search result storing section 109.

Therefore, for this point, it is not necessary to newly read out a target image and a reference image and perform SAD calculation. A search can be performed only by reading out an SAD value (e.g., “19”) corresponding to the search point (1, 0) stored in the search result storing section 109 (SUB104).

Note that, since information about the search point (1, 0) is not subsequently required, the information is deleted from the search result storing section 109 so as to free memory.

Also in this step, for a point with respect to which a search has been performed, a corresponding flag in the searched point storing section 110 is rewritten (see FIG. 12).

When S10 is completed, the flow goes to the next step (S102). In S102, a search is performed with respect to a point to the left of the reference point. Since the reference point is now (0, 0), an SAD value of a search point (−0, 0) is to be calculated. To calculate it, the motion vector detection control section 101 determines whether or not a search has been performed with respect to the search point (−0, 0), with reference to the status of a corresponding flag in the searched point storing section 110 (SUB101).

For example, as shown in FIG. 12, if the value of the flag is “00b”, the flow goes to SUB102. In this sub-step, a search is actually performed with respect to the search point (−1, 0).

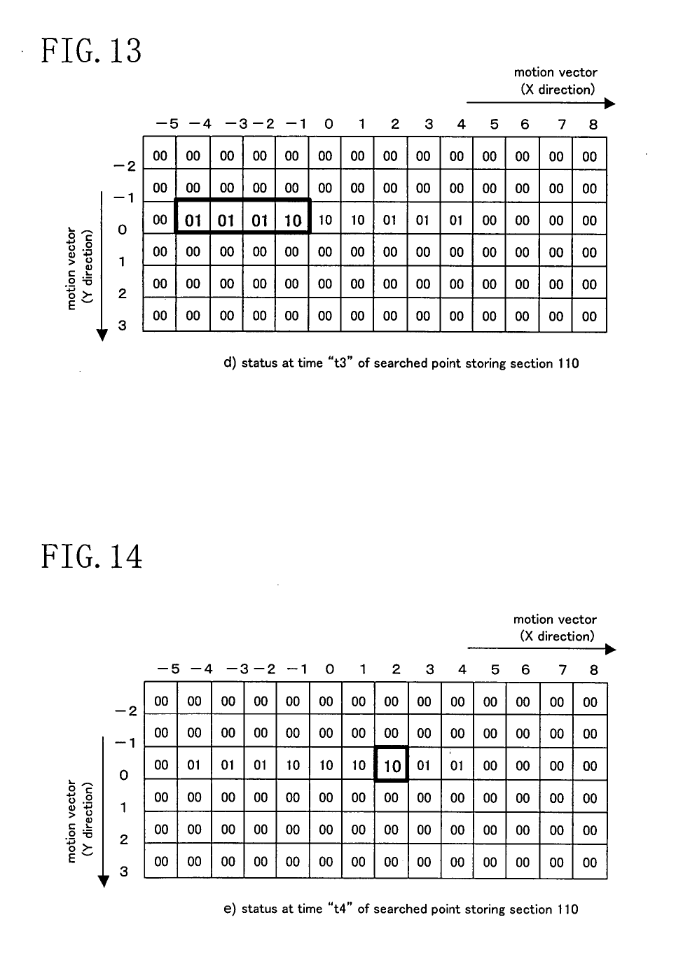

A search can be performed with respect to search points (−4, 0) to (0, 0) at the same time when a search is performed with respect to the search point (−0, 0). Among them, the calculated SAD values of the search points (−4, 0) to (−2, 0) are stored into the search result storing section 109 (see t3 in FIG. 7). Note that a search has already been performed with respect to the search point (0, 0), and the SAD value of this point is not subsequently used, and therefore, is not stored. For the points with respect to which a search has been performed, corresponding flags in the searched point storing section 110 are rewritten (see FIG. 13).

When a search has been completed with respect to the points to the left and right of the reference point, the SAD values are compared (S103). Since the SAD value of “19” of the right search point is smaller than the SAD value of “20” of the reference point (0, 0), the reference point is shifted to the right search point (1, 0), and the flow goes to S101 again.

In the next process, a point to the right of the reference point (1, 0) is searched for (S101). Since the reference point is now (1, 0), an SAD value of the search point (2, 0) is to be calculated. To calculate it, the motion vector detection control section 101 determines whether or not a search has been performed with respect to the search point (2, 0), with reference to the value of a corresponding flag in the searched point storing section 110 (SUB101).

For example, as shown in FIG. 13, if the value of the flag is “01b”, a search has already been completed, so that the SAD value of “18” is read out from the search result storing section 109 (SUB104). Information about the search point (2, 0) in the search result storing section 109 is not subsequently required and is therefore deleted (see t4 in FIG. 7). For a point with respect to which a search has been performed, a corresponding flag in the searched point storing section 110 is rewritten (see FIG. 14).

The next search is to be performed with respect to a point to the left of the search point (2, 0). However, a flag corresponding to this point in the searched point storing section 110 is “10b”, i.e., a search has already been completed (referred to as an invalid point), so that a search is not performed with respect to this point.

In comparison of SAD values in S103, since the SAD value of “18” of the right point is smaller than the SAD value of “19” of the reference point, the reference point is shifted to the right point (2, 0) and step S101 is executed again.

Thereafter, a search is similarly performed. Note that, when a search needs to be performed with respect to a point whose flag in the searched point storing section 110 has a value of “00b”, a search can be performed simultaneously with respect to five points enclosed by a thick quadrangular frame in FIG. 6.

As described above, in this embodiment, it is not necessary to redundantly read out data from the reference image storing section 103, so that the read efficiency is not deteriorated.

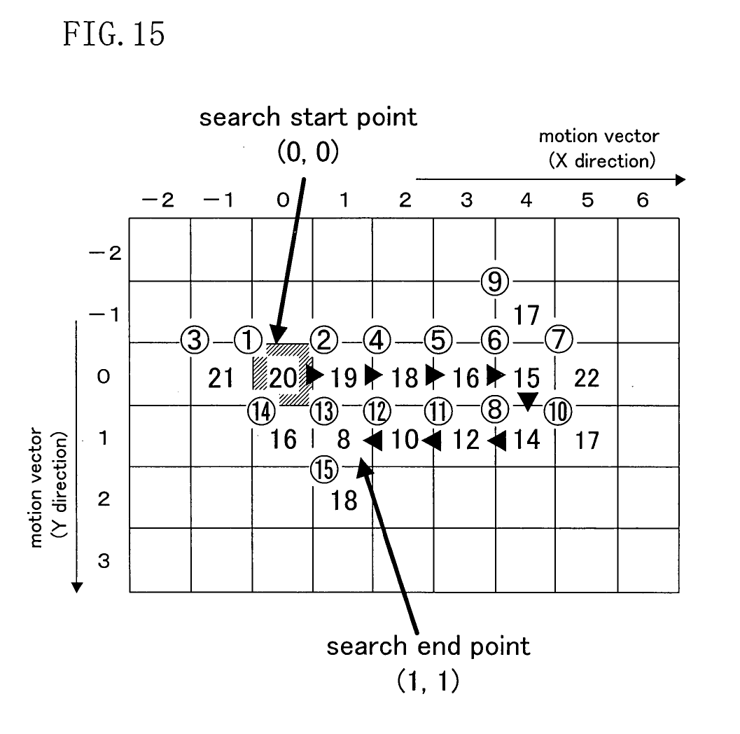

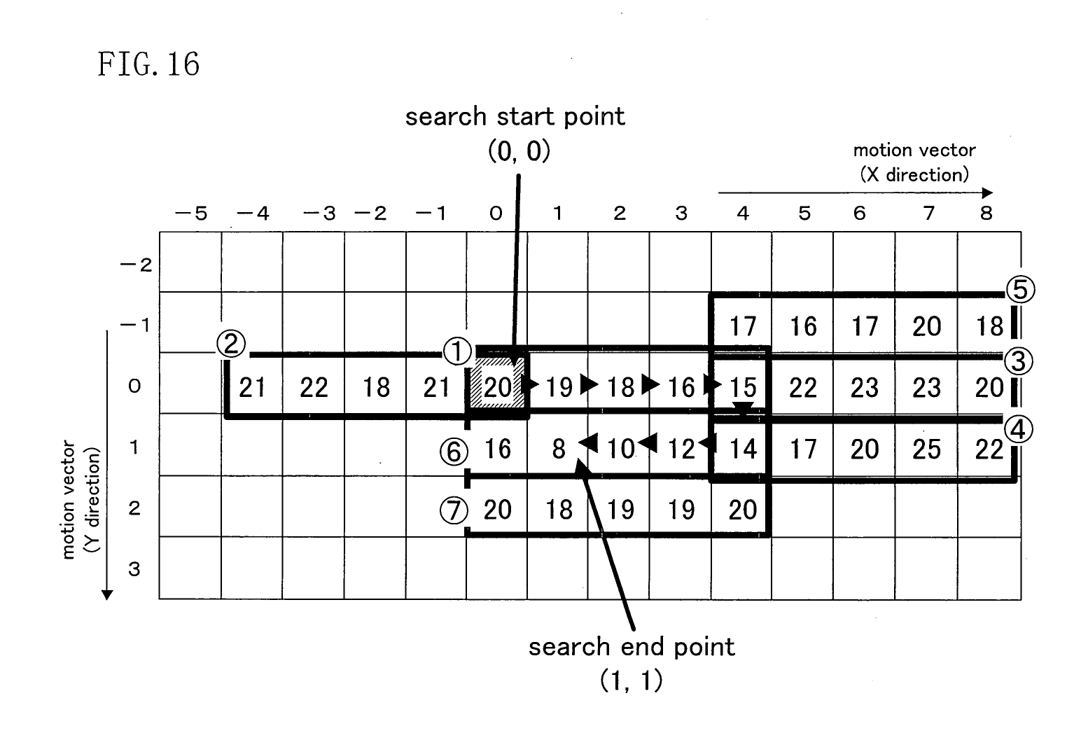

For example, if an SAD value is obtained for each point using the One-at-a-Time method, reading of a target image and a reference image and an SAD calculation need to be performed as many as 15 times until a search is completed with respect to the above-described reference regions having the SAD values, as shown in FIG. 15. In contrast, according to this embodiment, the number of times of reading can be reduced to only seven as shown in FIG. 16.

In other words, even when an attempt is made to read out only a search size of reference image which is packed in units of P pixels, it is highly likely to read unnecessary image data at the same time. Assuming the example of this embodiment, it is necessary to temporarily read out 20 pixels (horizontal direction)×16 pixels (vertical direction) so as to eventually read out 16 pixels (horizontal direction)×16 pixels (vertical direction). In this case, 4 pixels (horizontal direction)×16 pixels (vertical direction) located at left and right portions are unnecessary data (data which is not used in the process). The unnecessary data is conventionally not used and is discarded. In this embodiment, the unnecessary data is utilized to a maximum extent so as to perform a search with respect to all possible points (SAD values are calculated). Therefore, it is possible to remove the step of reading out data at the same location again and newly perform SAD calculation. In other words, it is possible to perform and complete a search quickly.

Note that, when a search is performed simultaneously with respect to five points as described in this embodiment, the following two reading orders allow a search with respect to the motion vector point (0, 0), for example.

A first reading order is packing pixel data “P2-1b→P2-2b→P2-3b→P3-1b→ . . . →P17-3b” required for a search with respect to the search points (−4, 0), (−3, 0), (−2, 0) and (−1, 0). A second reading order is packing pixel data “P2-2b→P2-3b→P2-4b→P3-2b→ . . . →P17-4b” required for a search with respect to the search points (0, 0), (1, 0), (2, 0), (3, 0) and (4, 0). Hereinafter, a point which has two image data reading orders when a motion vector search is performed is referred to as a “redundant search point”.

The motion vector detecting device 100 may be modified so that a search is performed with respect to the search point (0, 0) only when any one of the two reading orders is performed. For example, during reading with the first reading order, a search may not be performed with respect to the search point (0, 0), and a search may be performed with respect to only the four search points (−4, 0), (−3, 0), (−2, 0) and (−1, 0), and during reading with the second reading order, a search may be performed with respect to the search point (0, 0). In other words, when there are two reading orders for a search with respect to a motion vector point (in FIG. 16, redundant search points are (0, 0), (4, 0), (4, 1) and the like), a search is performed only with any one of the two reading orders.

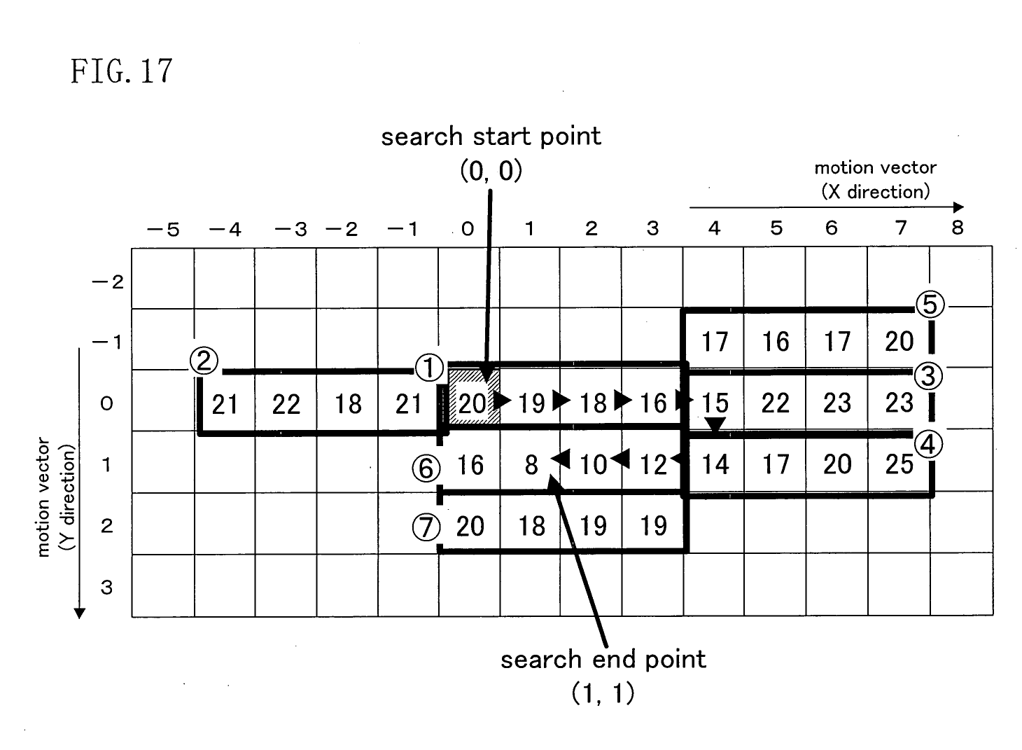

Thereby, a search is performed simultaneously with respect to four points instead of five points (see FIG. 17), so that the number of SAD calculating sections can be reduced. In other words, by causing the number of points with respect to which a search is performed simultaneously to be equal to the packing data number (P=4), the occurrence of a redundant search point can be prevented, so that the number of SAD calculating sections can be reduced.

Also, by enlarging the size of reference image data to be read out in the horizontal or vertical direction, the number of points with respect to which a search can be performed simultaneously can be increased, thereby making it possible to further increase the speed of a search.

For example, as compared to the reference image “P2-2b→P2-3b→P2-4b→P3-2b→ . . . →P17-4b” required for a search with respect to the search points (0, 0), (1, 0), (2, 0), (3, 0) and (4, 0), the read size is enlarged by one packing pixel in the horizontal direction, resulting in a reference image “P2-2b→P2-3b→P2-4b→P2-5b→P3-2b→ . . . →17-4b→P17-5b”. Thereby, a search can be performed simultaneously with respect to a total of nine points (search points (5, 0), (6, 0), (7, 0) and (8, 0) as well as the above-described search points).

On the other hand, in the case of a reference image “P2-2b→P2-3b→P2-4b→P3-2b→ . . . →P17-4b→P18-2b→P18-3b→P18-4b” which is obtained by enlarging a read size by one packing pixel in the vertical direction, a search can be performed simultaneously with respect to a total of ten points (search points (0, 1), (1,1), (2,1), (3,1) and (4,1) as well as the above-described search points). Also, by enlarging a read size both in the horizontal and vertical directions, the number of points with respect to which a search can be performed simultaneously can be increased, resulting in an increase in the processing speed.

Also, even when the read size is enlarged as described above, a redundant search point is present. For example, when the read size is enlarged in the horizontal direction, the search points (0, 0) and (8, 0) are redundant search points. When the read size is enlarged in the vertical direction, the search points (0, 0), (0, 1), (4, 0) and (4, 1) are redundant search points. For example, in the former case, a search may be performed simultaneously with respect to a total of eight points excluding the search point (8, 0), and in the latter case, a search may be performed simultaneously with respect to a total of eight points excluding the search points (4, 0) and (4, 1). Thereby, the occurrence of a redundant search point can be prevented, and the number of SAD calculation sections can be most reduced. In this case, the number of points with respect to which a search is performed simultaneously is a multiple of the packing data number P.

The search size may not be fixed in a process. For example, a search may be performed with respect to not only 16×16 pixels, but also 8×16 pixels, 16×8 pixels, and 8×8 pixels, and further 4×4 pixels (referred to as multi-search size search). In this case, a plurality of search sizes are used for a search, and an optimum result is selected.

If a search (SAD value calculation) is performed in units of a block of 4×4 pixels (sub-block), the result can be used to produce a result of a search (SAD value calculation) with another search size. Therefore, to achieve each search shown in this embodiment, the search is performed in units of 4×4 pixels (the minimum search size). In this case, 16 SAD calculating sections 108 are required so as to calculate an SAD value for 16×16 pixels in parallel.

Every time a search is completed with respect to each point, an SAD value for the 16×16-pixel size is calculated, and is transferred to the motion vector detection control section 101 or the search result storing section 109, thereby making it possible to achieve the same search process as that which has been shown in this embodiment.

Also, SAD values for other sizes, such as 4×4 pixels, 8×8 pixels, 16×8 pixels, 8×16 pixels and the like, are calculated and stored into the search result storing section 109. Each search is performed in units of 16×16 pixels. After all searches are completed, search points can be determined by considering which search size is most effective based on an SAD value for 16×16 pixels and SAD values for other sizes stored in the search result storing section 109.

Also, one-pixel thinning may be performed in the vertical direction, and the pixel may be used to perform an interlaced search (SAD value calculation). Thereby, an SAD value which would be obtained by a non-thinning search (referred to as a progressive search) can be produced. This is a considerably effective technique when interlaced encoding is performed.

Also, in this embodiment, since the SAD values of points with respect to which a search can be performed simultaneously are stored into the search result storing section 109 in the course of a search, the search result storing section 109 needs to have a considerably large capacity.

Such a capacity, which is previously secured, can be reduced by using a predetermined technique to reduce the amount of data stored in the search result storing section 109 when an amount of data exceeding a predetermined threshold is stored.

For example, as a first method, all search result data is erased from the search result storing section 109. At the same time, for a motion vector point corresponding to the erased data, a corresponding flag in the searched point storing section 110 is set to be “00b” indicating that a search has not been performed. If the result is required for a subsequent search, a search is performed again. Thereby, the upper limit of the capacity of the search result storing section 109 can be compensated for.

As another method, when a value which is larger than the SAD value of a search point when the storage means capacity exceeds the threshold is stored in the search result storing section 109, the search result data is erased. At the same time, for a motion vector point corresponding to the erased data, a corresponding flag in the searched point storing section 110 is set to be “10b” indicating that a search has been performed. Thereby, only search result data which is not required for a subsequent search can be erased.

Also, the latter method may be first executed, and when the amount of data exceeds the threshold after the execution, the former method may be executed. By combining both the methods in this manner, a more effective method is achieved.

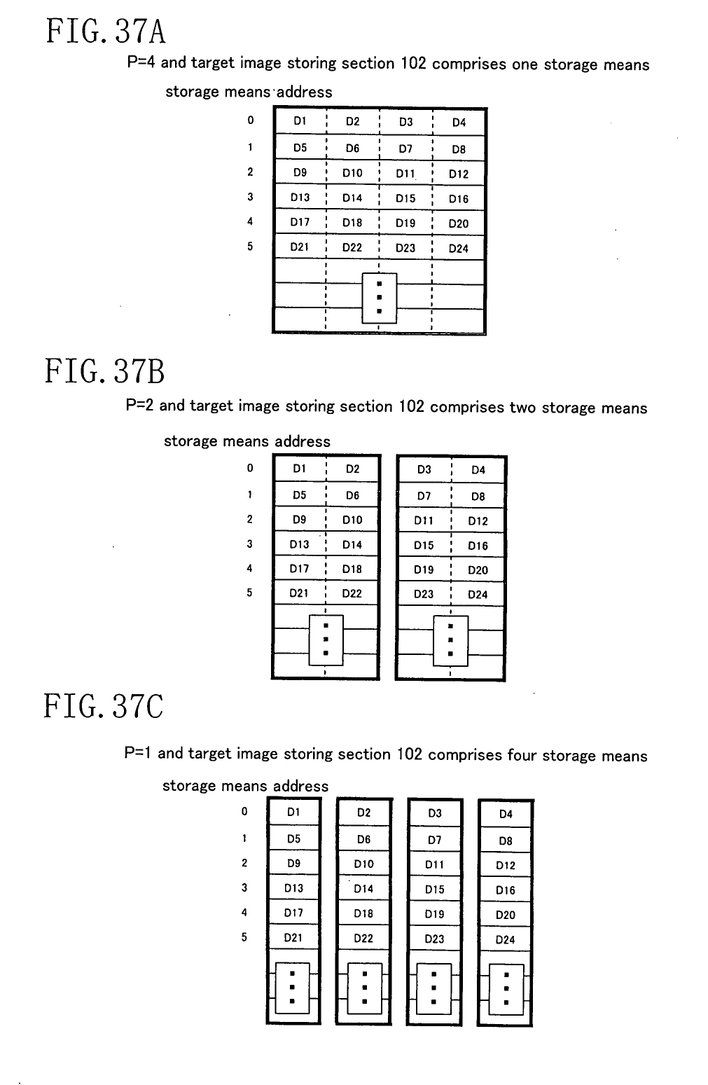

Also, even when the target image storing section 102 or the reference image storing section 103 is divided into a plurality of storage means, a similar effect can be obtained. Specifically, when an image is stored in the target image storing section 102 where P=4 as in this embodiment (see FIG. 37A), four pixels of image (e.g., D1 to D4) can be read by a single access. Even when it is assumed that P=2 and the target image storing section 102 is divided into two (see FIG. 37B), D1 and D2 can be read from one storage means while D3 and D4 are read from the other storage means, i.e., four pixels of image can be read by a single access. Alternatively, even when it is assumed that P=1 and the target image storing section 102 is divided into four (see FIG. 37C), four pixels of image D1, D2, D3 and D4 can be read from the respective storage means.

Thus, if the target image storing section 102 or the reference image storing section 103 is divided into a plurality of storage means, then when each storage means is operated while being supplied with clock, clock supply can be suspended for a storage means which is not being used, thereby making it possible to effectively reduce power consumption.

### Embodiment 2 of the Invention

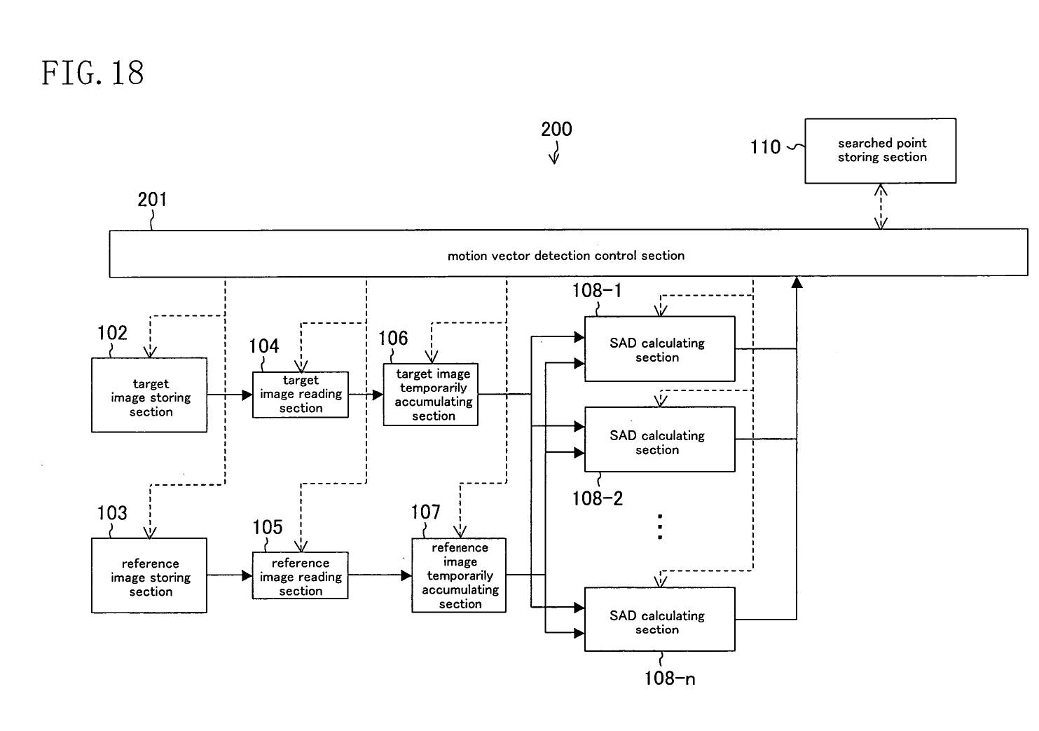

FIG. 18 is a block diagram showing a configuration of a motion vector detecting device 200 according to Embodiment 2 of the present invention. As shown in FIG. 18, the motion vector detecting device 200 is the same as the motion vector detecting device 100 of Embodiment 1, except that the search result storing section 109 is removed and a motion vector detection control section 201 is provided instead of the motion vector detection control section 101.

Note that, also in Embodiment 2, it is assumed that the search size is 16 pixels×16 pixels, the packing data number P is 4, and the number of SAD calculating sections n is 5.

It has been assumed in Embodiment 1 that only the SAD value of a reference point is transferred to the motion vector detection control section 101, while the SAD values of the other points with respect to which a search can be performed simultaneously are stored into the search result storing section 109. In this embodiment, however, the SAD values of all points (five points) with respect to which a search can be performed are transferred to the motion vector detection control section 201.

The motion vector detection control section 201 controls SAD value calculation as described below. In this embodiment, among the SAD values of all points (five points) with respect to which a search can be performed, a point having a minimum SAD value is selected and processed.

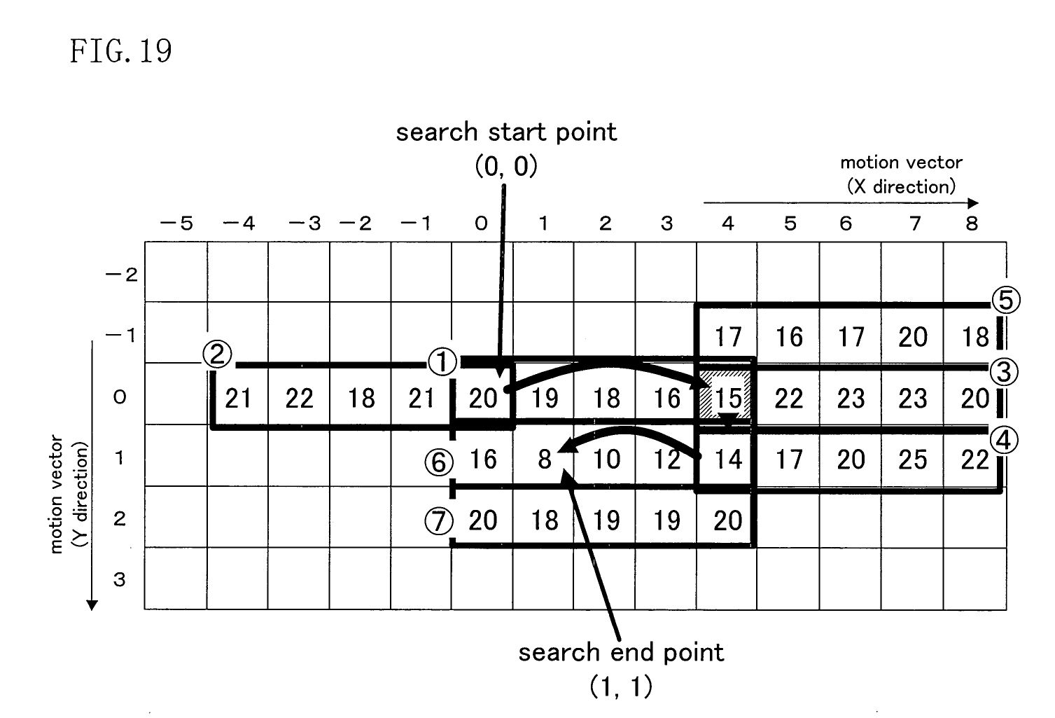

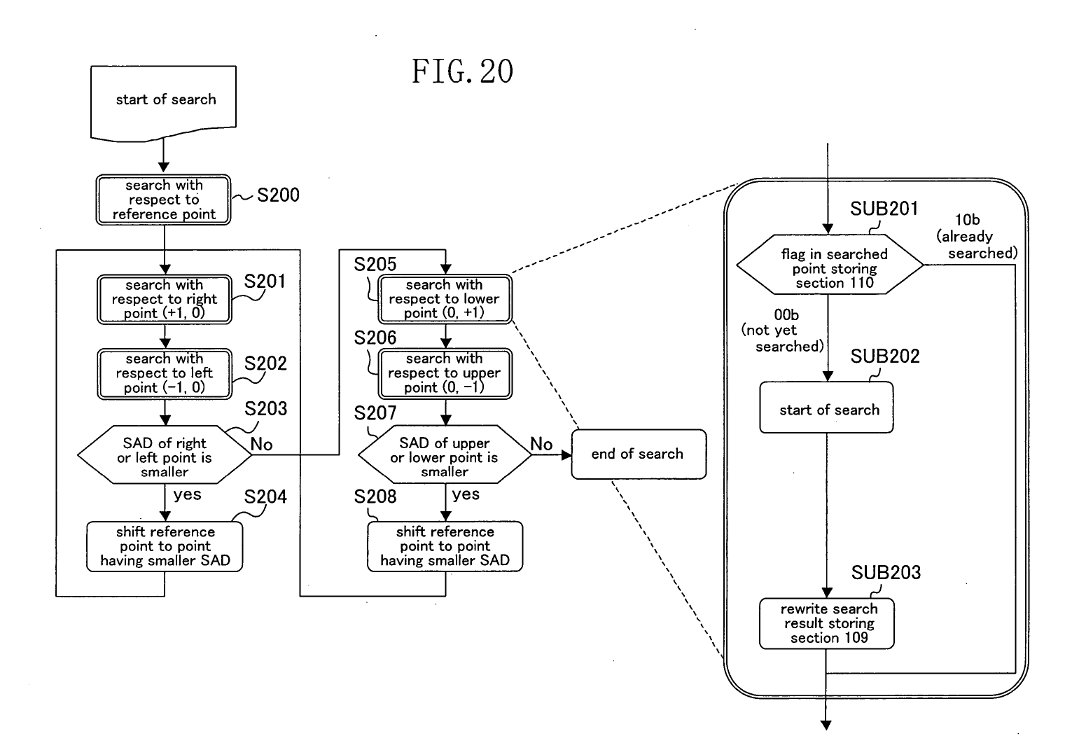

Specifically, processes will be described with reference to FIGS. 19 and 20. FIG. 20 is a flowchart showing a process performed in the motion vector detecting device 200. Note that, in steps of a search process (S200 to S202 and S205 and S206), sub-steps (SUB201 to SUB203) are performed in each search.

Initially, an SAD value is calculated for a reference point (0, 0) (see S200 in FIG. 20). At the same time, SAD values can be calculated for search points (1, 0) to (4, 0) for the same reason that has been described in Embodiment 1. All SAD values of the five points in this case are transferred to the motion vector detection control section 201.

In the example of FIG. 19, the SAD value of 20 of the search point (0, 0), the SAD value of 19 of the search point (1, 0), the SAD value of 18 of the search point (2, 0), the SAD value of 16 of the search point (3, 0), and the SAD value of 15 of the search point (4, 0) are transferred. In this example, the SAD value of 15 is the minimum SAD value. The next reference point is set to be (4, 0) and the flow goes to the next search (S201 in FIG. 20).

Note that, in SUB203, flags corresponding to all the five points in the searched point storing section 110 are rewritten to “10b”.

In S201 of FIG. 20, a search is performed with respect to a point (5, 0) to the right of the reference point. When a search is performed with respect to this point, a search can be performed simultaneously with respect to five points (4, 0) to (8, 0). Among these five points, the point (4, 0) has a minimum SAD value of 15 in the example of FIG. 19.

In S202, a search is to be performed with respect to a point (3, 0) to the left of the reference point (4, 0). However, since a search has been performed with respect to the point (3, 0) (since a corresponding flag in the searched point storing section 110 is “10b”), a search is not performed again.

Next, in S203, the SAD values are compared. As a result of the search with respect to the left and right points, an SAD value which is smaller than the SAD value of 15 of the reference point (4, 0) has not been detected in the example of FIG. 19. Therefore, the flow goes to processes in S205 and thereafter (an upward point search and a downward point search).

In S205, a search is performed with respect to a point (4, 1) below the reference point (4, 0) and points (5, 1) to (8, 1) with respect to which a search can be performed at the same time so as to obtain a point having a minimum SAD value. In this example, the SAD value of 14 of the point (4, 1) is assumed to be the result of the downward point search.

In S206, a search is performed with respect to a point (4, −1) above the reference point (4, 0) and points (5, −1) to (8, −1) with respect to which a search can be performed at the same time so as to obtain a point having a minimum SAD value. In this example, the SAD value of 16 of the point (5, −1) is assumed to be the result of the upward point search.

In S207, the SAD values are compared. As a result of the upward and downward point searches, the SAD value of 14 of the lower point (4, 1) is smaller than the SAD value of 15 of the reference point (4, 0). Therefore, the reference point is shifted to (4, 1), and the flow returns to the process of S201 again.

In S201, a search is to be performed with respect to the point (5, 1) to the right of the reference point (4, 1). However, since a search has already been performed with respect to the point (5, 1), a search is not performed again.

In S202, a search is to be performed with respect to points to the left of the reference point (4, 1). A search is performed simultaneously with respect to the points (0, 1) to (4, 1). In this example, as a result of the search, the SAD value of 8 of the point (1, 1) is minimum and this is set to be the result of the leftward point search.

Next, in S203, the SAD values are compared. In this example, the SAD value of 8 of the lower point (1, 1) is smaller than the SAD value of 14 of the reference point (4, 1), so that the reference point is shifted to the point (1, 1). By performing similar processes, a search is performed with respect to points above and below and to the left and right of this reference point. In this example, since the SAD values are not smaller than 8, a reference block corresponding to the reference point (1, 1) is the result of the motion vector detection.

As described above, in this embodiment, every time a search is performed with respect to a plurality of points, a point having a minimum SAD value is selected from those points and the next search is performed. Therefore, the search result storing section 109, which is required in Embodiment 1, is not required. Therefore, a more compact motion vector detecting device can be achieved.

Note that, also in this embodiment, the method for preventing redundant search points as described in Embodiment 1 (“the packing data number P=the number of points with respect to which a search is performed simultaneously”) is effective. Also, in this embodiment, by eliminating redundant search points, the number of flags stored in the searched point storing section can be reduced. For example, if a search has been performed with respect to the search point (0, 0), a search has also been performed with respect to the search points (1, 0) to (3, 0). In other words, a flag can be shared by these four points.

In this embodiment, each point has two search statuses, i.e., “not yet searched” or “already searched”. Therefore, the flag is not necessarily of two bits as in Embodiment 1.

Also, the method of Embodiment 1 for reading out a reference image which is enlarged in the horizontal or vertical direction so as to increase the number of points with respect to which a search is performed simultaneously, is significantly effective for this embodiment.

Note that, when a reference point is shifted, the process speed can be increased by previously confirming the value of a corresponding flag in the searched point storing section 110.

The motion search method of this embodiment comprises a step of receiving a search result and determining the next search point (referred to as a next search point determining step) and a step of actually executing a search to obtain a search result (referred to as an SAD value calculating step). By repeatedly performing the method, a motion vector can be detected.

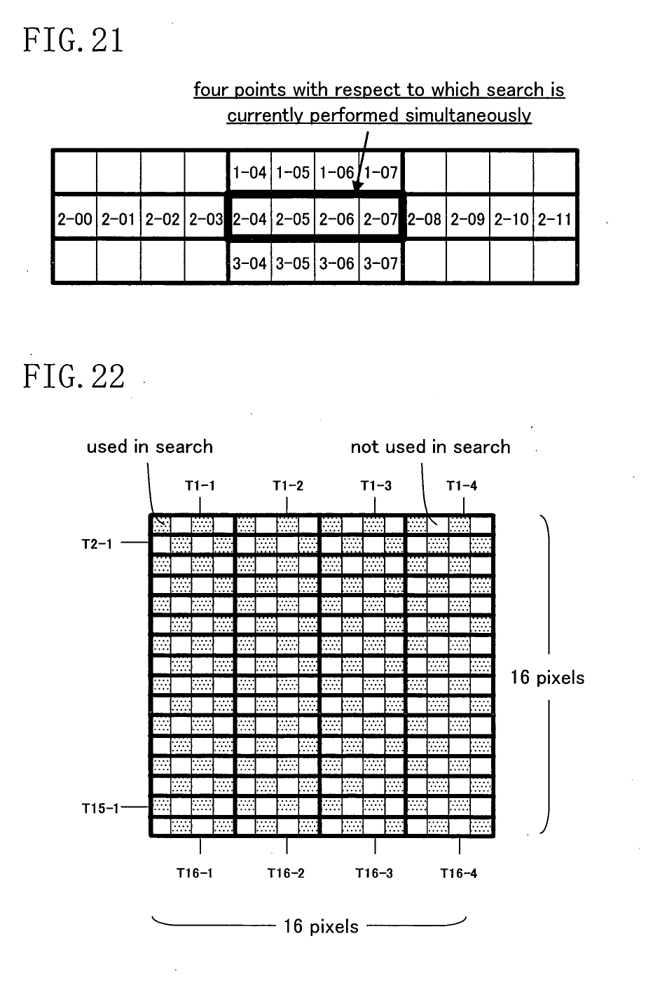

It is now assumed that, in the SAD value calculating step, for example, a search is performed with respect to four points located as shown in FIG. 21. In this case, as a search result, the SAD value of “2-04” is assumed to be smallest. A method (next search point determining step) of determining the next point when a reference point for a motion vector search is shifted to “2-04” after this search will be described.

A search is to be performed with respect to a point “2-05” to the right of the reference point “2-04”. However, since a search has already been performed with respect to this point, a search is to be performed with respect to a point “2-03” to the left of the reference point “2-04”. If a search has been completed with respect to the “2-03” point (the searched point storing section 110 determines whether or not the search has been completed), a search is to be performed with respect to a point “3-04” below the point reference point “2-04”. If a search has been completed with respect to the point “3-04”, a search is to be performed with respect to a point “1-04” above the reference point “2-04”. If a search has been completed with respect to all surrounding search points, “2-04” is set as a motion vector and the search process is ended.

It is also assumed that a search is performed with respect to the four points located as shown in FIG. 21. As a result of the search, the SAD value of “2-05” is assumed to be smallest. A method (next search point determining step) for determining the next point when the reference point is shifted to “2-05” after this search will be described.

A search is to be performed with respect to a point “2-06” to the right of the reference point “2-05”. However, since a search has already been performed with respect to this point, a search is to be performed with respect to the point “2-04” to the left of the reference point “2-05”. Since a search has been completed with respect to this point, a search is to be performed with respect to a point “3-05” below the reference point “2-05”. If a search has already been completed with respect to the point “3-05”, a search is to be performed with respect to a point “1-05” above the reference point “2-05”. If a search has been completed with respect to all surrounding points, the reference point “2-05” is set as a motion vector and the search process is ended. It is also assumed that a search is performed with respect to the four points located as shown in FIG. 21, and as a result, the SAD value of a point “2-06” or “2-07” is smallest. In this case, a similar next point determining method (next search point determining step) is performed.

As described above, when a search is performed with respect to four points, the next point search location for each point is previously determined based on the value of a corresponding flag in the searched point storing section 110. Thereby, immediately after a search is completed, the next search can be performed with respect to a determined point, leading to an increase in the processing speed.

### Embodiment 3 of the Invention

Embodiment 3 is an exemplary device for performing SAD value calculation using sub-sampled image data instead of all image data having a search size in order to calculate an SAD value with higher speed.

The motion vector detecting device of Embodiment 3 has the same components as those of Embodiment 1 (FIG. 1), except that image data is stored in the target image storing section 102 and the reference image storing section 103 in a different manner.

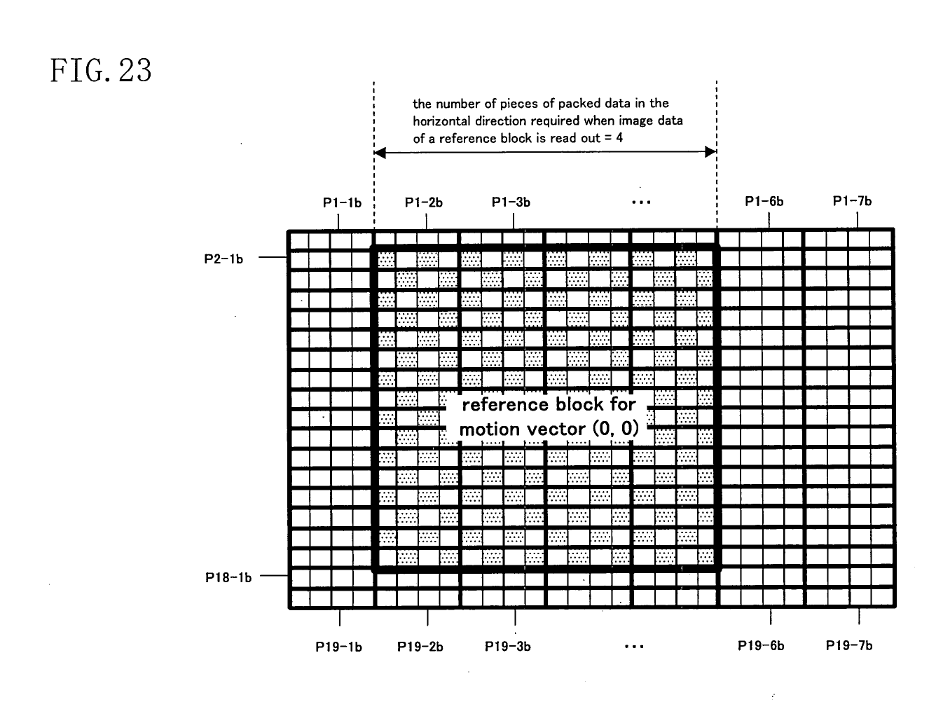

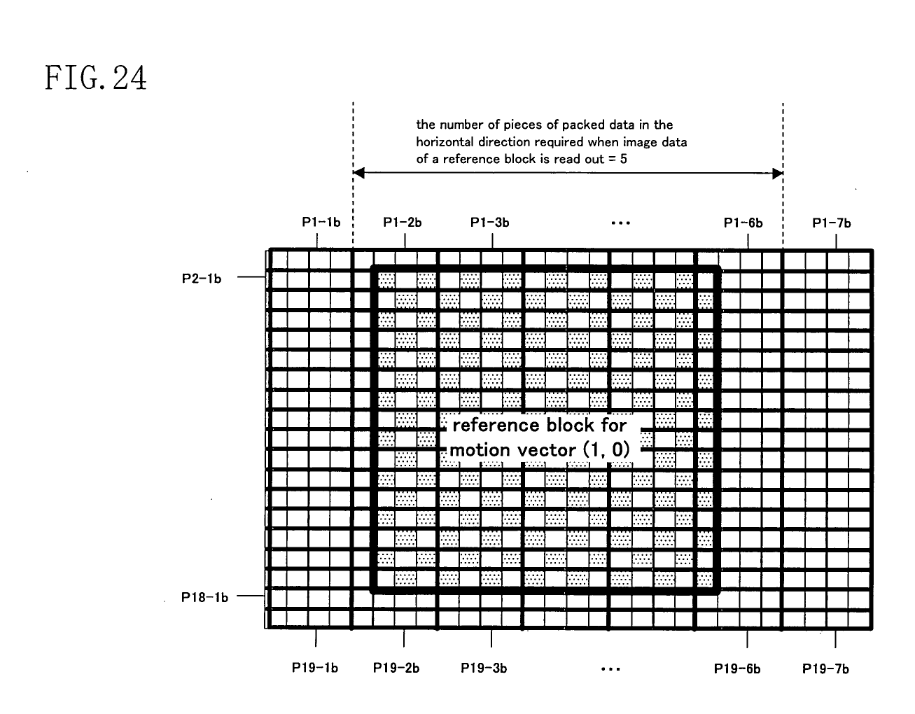

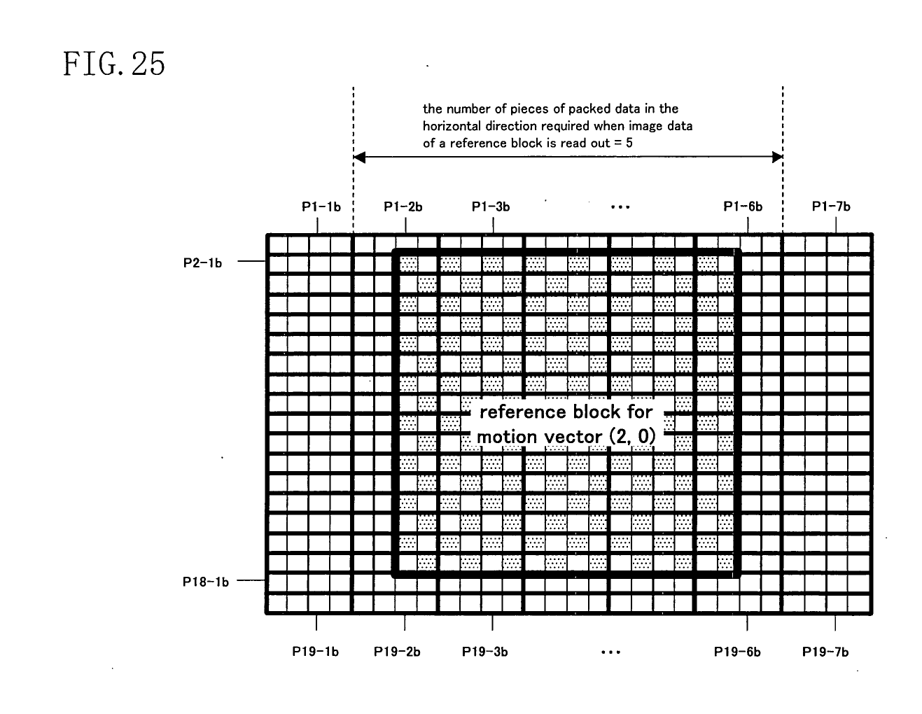

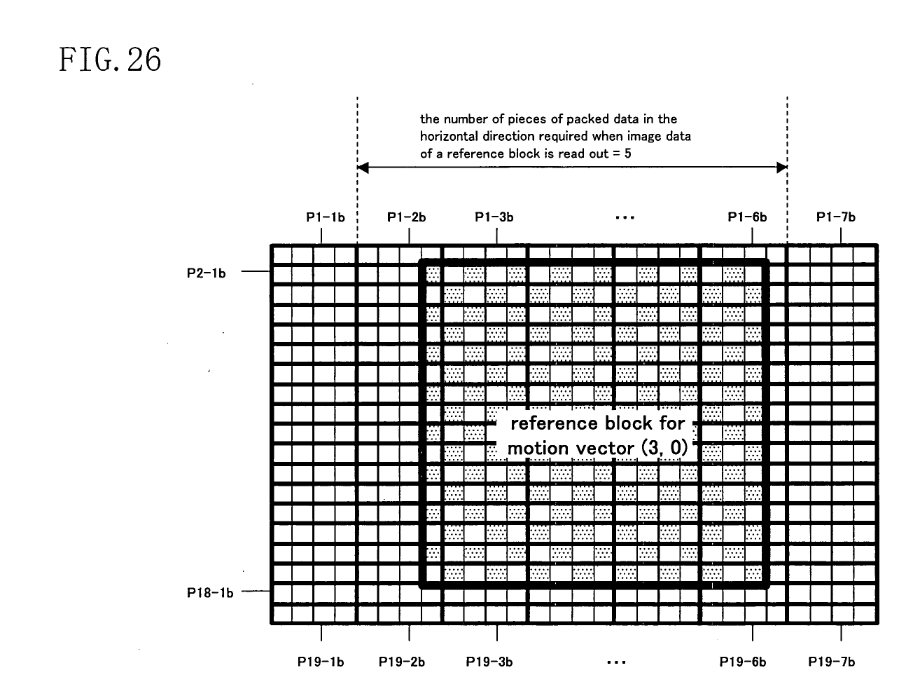

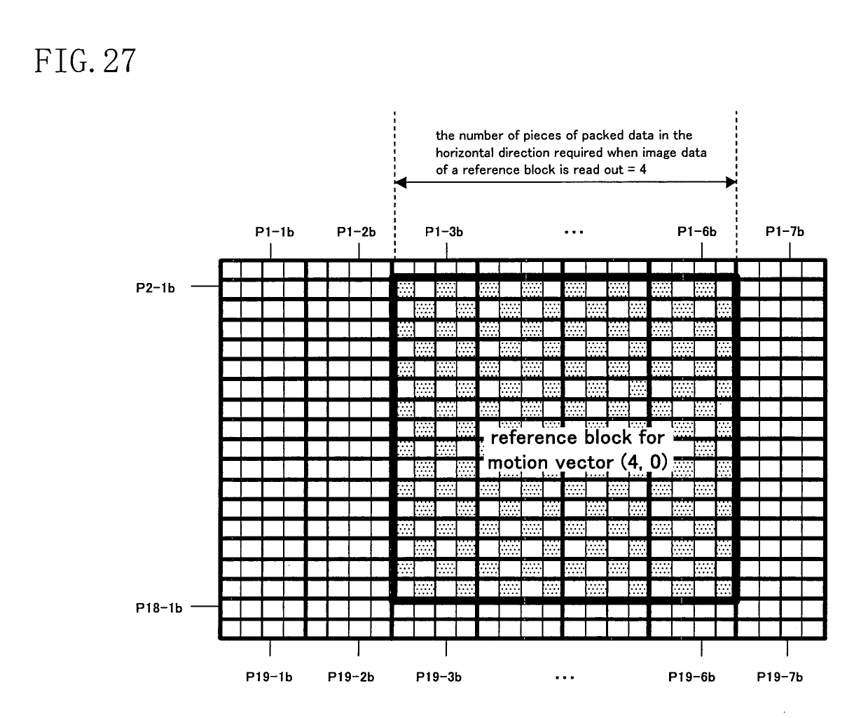

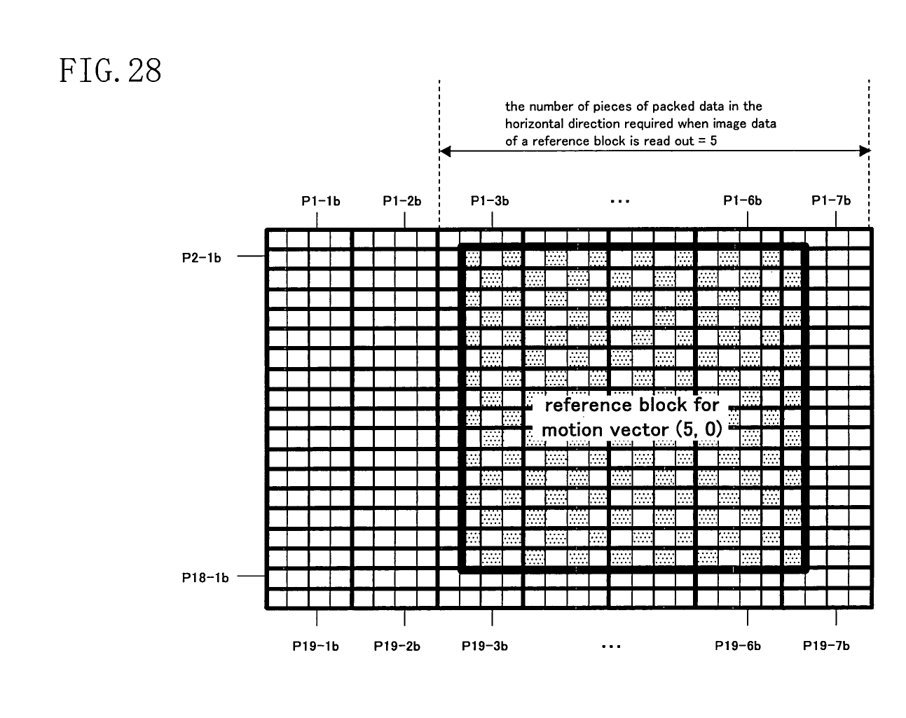

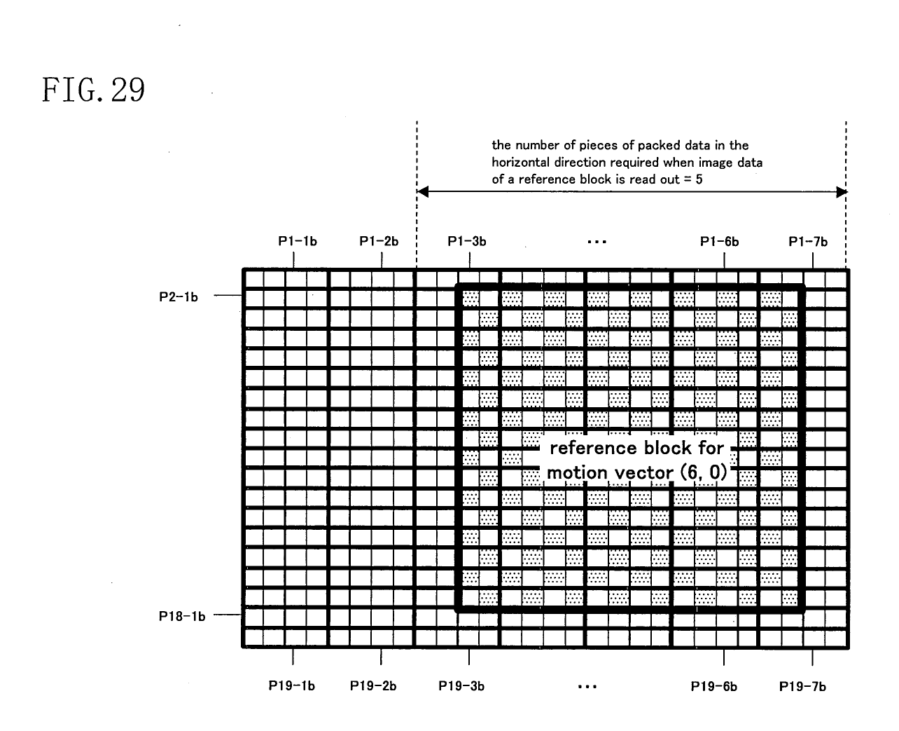

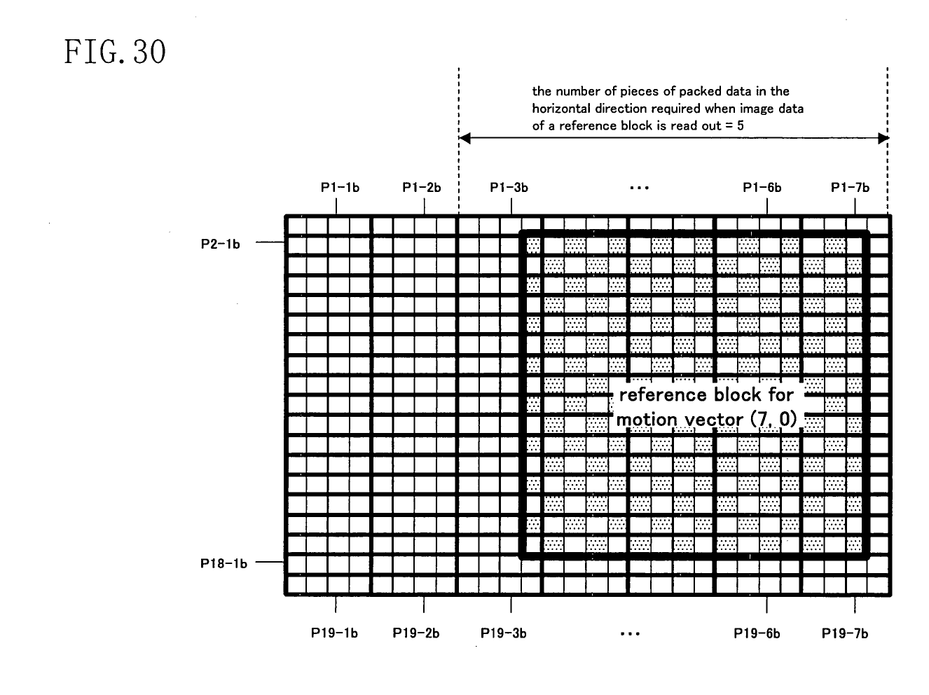

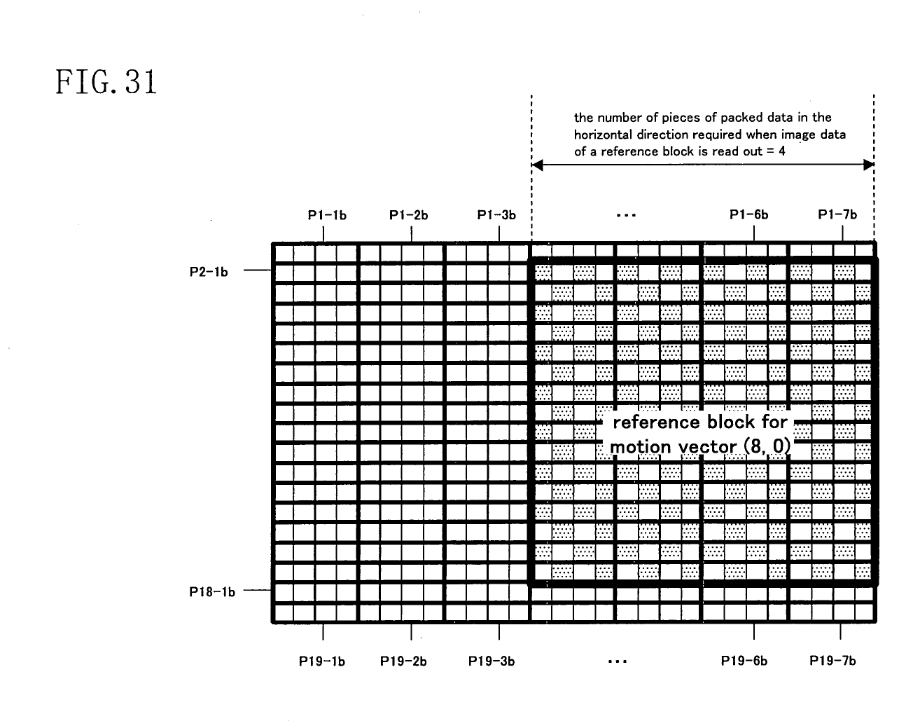

FIG. 22 shows a sub-sampled target image. FIGS. 23 to 31 show sub-sampled reference images which are used for a search with respect to motion vector points (0, 0) to (8, 0), respectively. As can be seen from these figures, only one half of packed image data is used for a search, while the other half is discarded without being used, though it is read out.

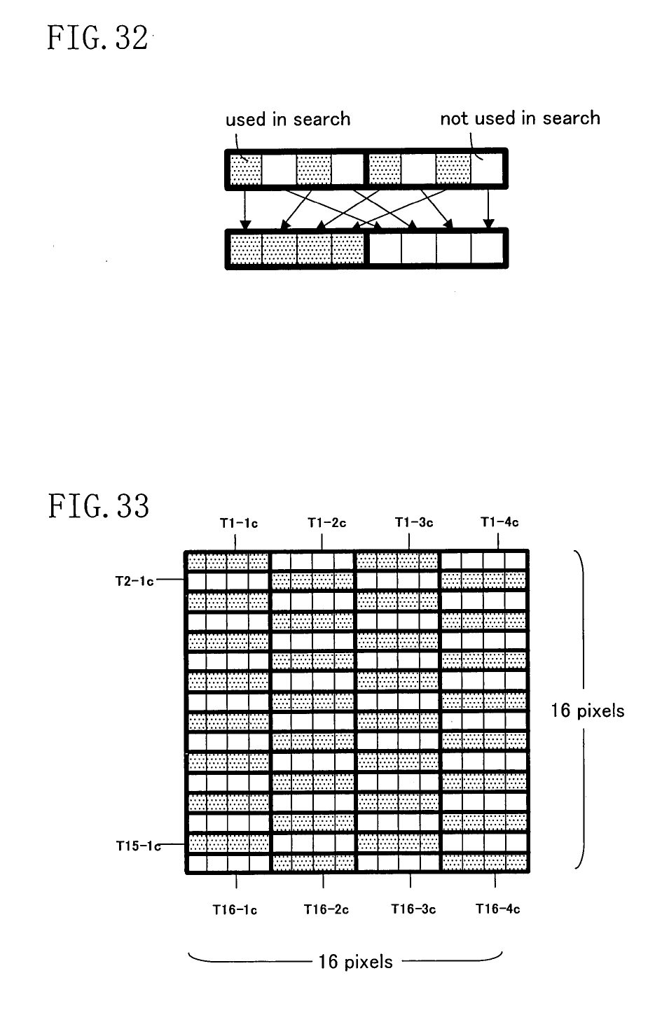

In the target image storing section 102 and reference image storing section 103, as shown in FIG. 32, each of four pixels which are to be used and four pixels which are not to be used are arranged serially, and are packed again before storage. Thereby, only image data to be used can be read out quickly.

Only an image to be used as a target image may be read out with the following order: T1-1c→T1-3c→T2-2c→T2-4c→T3-1c→T3-3c→ . . . →T16-2c→T16-4c (see FIG. 33).

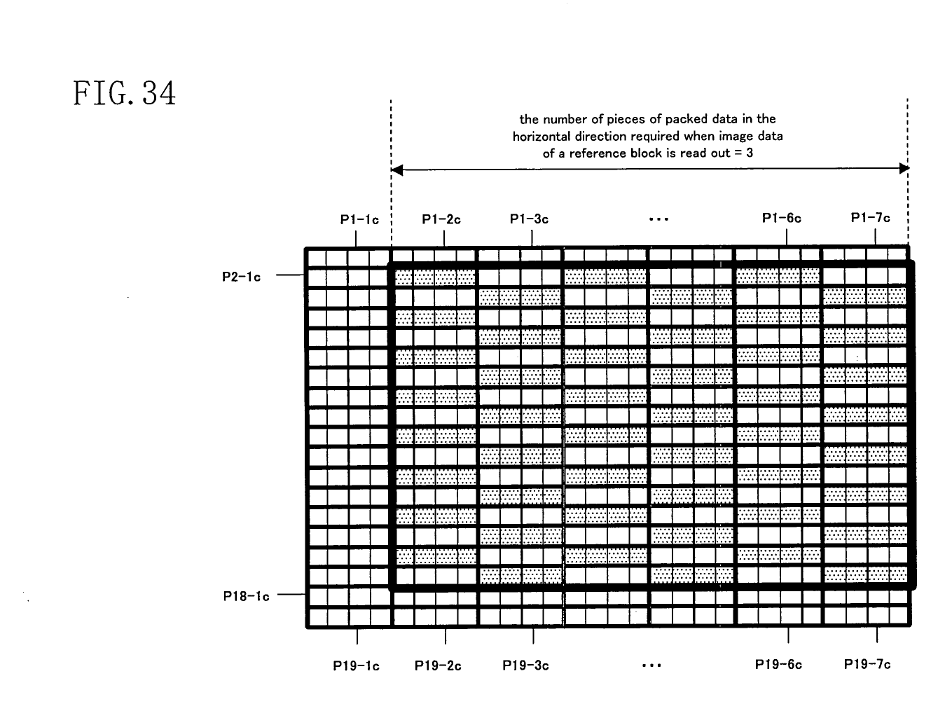

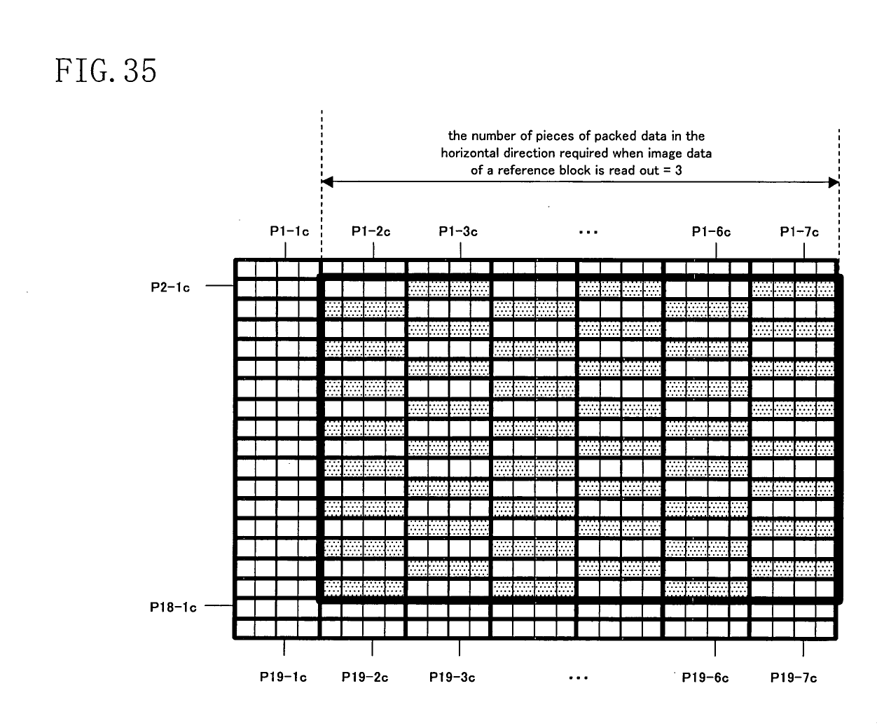

Only an image to be used as a reference image may be read out with two reading orders. The orders depend on the value of the x coordinate of a motion vector. When the x coordinate of the motion vector is even, the image is read out with the following order: P2-2c→P2-4c→P2-6c→P3-3c→P3-5c→P3-7c→ . . . →P17-3c→P17-5c→P17-7c (see FIG. 34). When the x coordinate of the motion vector is odd, the image is read out with the following order: P2-3c→P2-5c→P2-7c→P3-2c→P3-4c→P3-6c→ . . . →P17-2c→P17-4c→P17-6c (see FIG. 35).

When the image data of FIG. 34 is used, a search can be performed with respect to search points (0, 0), (2, 0), (4, 0), (6, 0) and (8, 0). This is generalized as follows: a search can be performed with respect to a total of five points (4×P, Q), (4×P+2, Q), (4×P+4, Q), (4×P+6, Q) and (4×P+8, Q).

When the image data of FIG. 35 is used, a search can be performed with respect to search points (1, 0), (3, 0), (5, 0) and (7, 0). This is generalized as follows: a search can be performed with respect to a total of four points (4×P+1, Q), (4×P+3, Q), (4×P+5, Q) and (4×P+7, Q). Note that P and Q are integers.

As described above, although this embodiment is different from Embodiments 1 and 2 in the locations of points with respect to which a search is performed simultaneously, sub-sampled pixels can be used to perform a motion vector search (SAD value calculation) with high speed by performing a process similar to that of Embodiment 1 or 2.

Note that the method of reducing the number of redundant search points and the method of increasing the number of points with respect to which a search is performed simultaneously by enlarging a reference image in the horizontal or vertical direction, which are described in Embodiments 1 and 2, are also considerably effective for this embodiment.

### Embodiment 4 of the Invention

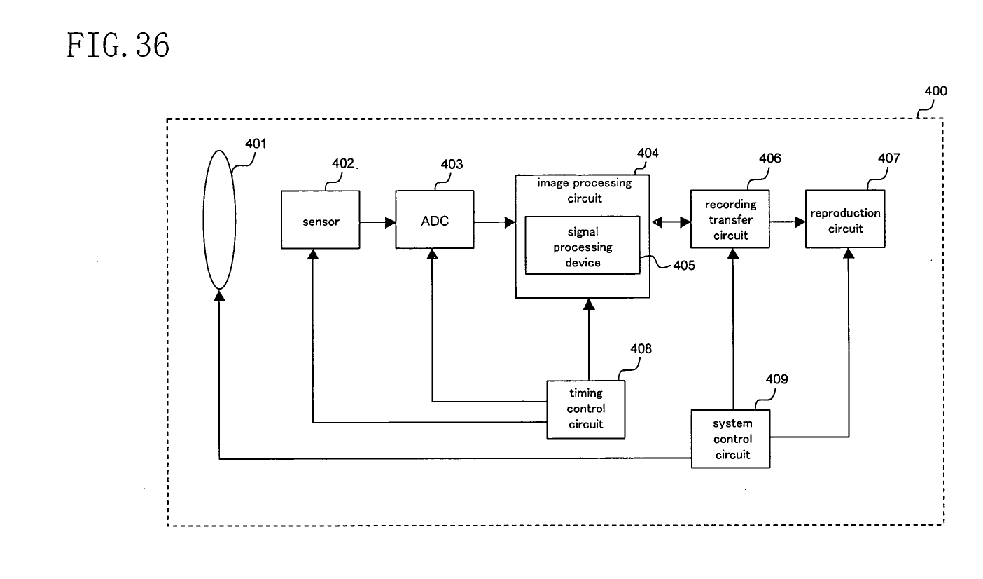

FIG. 36 is a block diagram showing a configuration of an imaging system 400 (e.g., a digital still camera (DSC)) according to Embodiment 4 of the present invention. As shown in FIG. 36, the imaging system 400 comprises an optical system 401, a sensor 402, an AD converter 403 (abbreviated as ADC in FIG. 36), an image processing circuit 404, a recording transfer circuit 406, a reproduction circuit 407, a timing control circuit 408, and a system control circuit 409.

The optical system 401 brings incident image light into focus on the sensor 402.

The sensor 402 is driven by the timing control circuit 408, accumulates image light focused by the optical system 401, and converts the image light into an electrical signal (photoelectric conversion).

The AD converter 403 converts the electrical signal output from the sensor 402 into a digital signal, and outputs the digital signal to the image processing circuit 404.

The image processing circuit 404 performs image processing, such as a Y/C process, an edge process, enlargement and reduction of an image, an image compression/decompression process, and the like. The image-processed signal is output to the recording transfer circuit 406. The image processing circuit 404 comprises a signal processing device 405 for image compression. The signal processing device 405 is any of the motion vector detecting devices of Embodiments 1 to 3.

The recording transfer circuit 406 records or transfers an output of the image processing circuit 404 to a medium.

The reproduction circuit 407 reproduces a signal recorded or transferred by the recording transfer circuit 406.

The timing control circuit 408 controls timing of operations of the optical system 401, the sensor 402, the AD converter 403 and the image processing circuit 404.

The system control circuit 409 controls an operation of the whole system.

Note that the image processing by the signal processing device 405 of this embodiment is applicable not only to a signal based on image light focused on the sensor 402 via the optical system 401, but also to, for example, when an image signal input as an electrical signal from an external device is processed.

The packing unit of target images is not necessarily the same as the packing unit of reference images. For example, the present invention is also applicable when target images are packed in units of eight pixels while reference images are packed in units of four pixels, i.e., target images and reference images are packed in different units.

As described above, the motion vector detecting method of the present invention can detect a motion vector without redundantly reading out data of a reference region when the data of the reference region is packed and stored in a memory device. Therefore, the motion vector detecting method of the present invention is useful as a motion vector detecting device, an imaging system or the like for use in motion compensation predictive encoding in moving image compression encoding.

What is claimed is:

1. A method for detecting a motion vector in units of a block using a rectangular target image packed in units of a first pixel number and stored in a target image storing section and a rectangular reference image packed in units of a second pixel number and stored in a reference image storing section when moving image compression encoding is performed, comprising:
a target image reading step of reading the target image from the target image storing section;
a reference image reading step of reading image data having the same size as that of the target image and, in addition, at least one or more reference image packing units of extra image data from the reference image storing section; and
a correlation degree calculating step of calculating a degree of correlation between the target image and each of a plurality of reference blocks, wherein each reference block is a block of image data having the same size of that of the target image within the image data read out in the reference image reading step, and the reference blocks have locations different from each other.

2. The method of claim 1, further comprising:
a target image rearranging step of rearranging the target image before the target image reading step so that pixels used and pixels not used in calculation of a degree of correlation are arranged alternately every target image packing unit;
a reference image rearranging step of rearranging the reference image before the reference image reading step so that pixels used and pixels not used in calculation of a degree of correlation are arranged alternately every reference image packing unit; and
the target image reading step and the reference image reading step read out only packed data including pixels used in calculation of a degree of correlation.

3. The method of claim 1, wherein the number of reference blocks for which a degree of correlation is calculated in the correlation degree calculating step is the same as or a multiple of the number of packed pixels.

4. The method of claim 1, wherein the amount of the extra image data read out in the reference image reading step is an amount which can be simultaneously calculated in the correlation degree calculating step.

5. The method of claim 1, further comprising:
a calculation result storing step of storing each degree of correlation obtained in the correlation degree calculating step into a search result storing section,
wherein, when a degree of correlation corresponding to a reference block which is to be used in calculation of a degree of correlation is stored in the search result storing section, the correlation degree calculating step reads out the stored degree of correlation.

6. The method of claim 5, further comprising:
a sub-block correlation degree calculating step of calculating a degree of correlation between a sub-block which is a region smaller than the target image, and a plurality of sub-reference blocks which are blocks of image data having the same size as that of the sub-block within the image data read out in the reference image reading step and have locations different from each other;
a sub-block calculation result storing step of storing each degree of correlation obtained in the sub-block correlation degree calculating step into the search result storing section; and
a selection step of selecting either of each degree of correlation obtained in the correlation degree calculating step and stored in the search result storing section or each degree of correlation obtained in the sub-block correlation degree calculating step and stored in the search result storing section.

7. The method of claim 5, wherein the correlation degree calculating step has a mode in which the degree of correlation is calculated for each even-numbered line of an image and a mode in which the degree of correlation is calculated for each odd-numbered line of the image.

8. The method of claim 5, further comprising:
a deletion step of deleting a correlation value stored in the search result storing section when a capacity of the search result storing section used to store correlation values exceeds a predetermined threshold.

9. The method of claim 8, wherein the deletion step deletes all stored correlation values.

10. The method of claim 8, wherein the deletion step deletes correlation values excluding a correlation value indicating the strongest correlation from the search result storing section.

11. The method of claim 5, further comprising:
a flag managing step of managing a flag for determining whether or not the degree of correlation has been calculated, for each reference block.

12. The method of claim 1, wherein the target image reading step, the reference image reading step, and the correlation degree calculating step are repeatedly executed until a reference block having a degree of correlation higher than those of reference blocks located above and below and to the left and right thereof is found, and
the correlation degree calculating step determines a reference block for which a correlation value is next determined, depending on a location of a reference block corresponding to a correlation value indicating the strongest correlation among the plurality of degrees of correlation previously calculated in the correlation degree calculating step.

13. The method of claim 12, further comprising:
a flag managing step of managing a flag for determining whether or not the degree of correlation has been calculated, for each reference block.

14. The method of claim 13, wherein the correlation degree calculating step determines a reference block for which a correlation value is next determined, depending on a value of the flag.

15. A device for detecting a motion vector in units of a block using a rectangular target image packed in units of a first pixel number and stored in a target image storing section and a rectangular reference image packed in units of a second pixel number and stored in a reference image storing section when moving image compression encoding is performed, comprising:
a target image reading section for reading the target image from the target image storing section;
a reference image reading section for reading image data having the same size as that of the target image and, in addition, at least one or more reference image packing units of extra image data from the reference image storing section;
a plurality of SAD calculating sections for calculating a degree of correlation between the target image and a reference block which is image data having the same size of that of the target image within the image data read out by the reference image reading section;
a search result storing section for storing the degree of correlation; and
a motion vector detection control section for transferring a plurality of reference blocks having locations different from each other to the respective SAD calculating sections which in turn calculate a degree of correlation, and using one of the degrees of correlation to determine a reference block for which a degree of correlation is next calculated in the SAD calculating section, and storing the other degrees of correlation into the search result storing section.

16. A device for detecting a motion vector in units of a block using a rectangular target image packed in units of a first pixel number and stored in a target image storing section and a rectangular reference image packed in units of a second pixel number and stored in a reference image storing section when moving image compression encoding is performed, comprising:
a target image reading section for reading the target image from the target image storing section;
a reference image reading section for reading image data having the same size as that of the target image and, in addition, at least one or more reference image packing units of extra image data from the reference image storing section;
a plurality of SAD calculating sections for calculating a degree of correlation between the target image and a reference block which is image data having the same size of that of the target image within the image data read out by the reference image reading section; and
a motion vector detection control section for transferring a plurality of reference blocks having locations different from each other to the respective SAD calculating sections which in turn calculate a degree of correlation, and determining a reference block for which a degree of correlation is next calculated in the SAD calculating section, depending on the location of a reference block corresponding to a correlation value indicating the strongest correlation among the plurality of degrees of correlation.

17. An imaging system comprising:
the device of claim 15;
a sensor for converting image light into an image signal;
an optical system for bringing incident image light into focus on the sensor; and
an AD converter for converting the image signal into digital data and outputting digital data to the motion vector detecting device.

18. An imaging system comprising:
the device of claim 15; and
an AD converter for converting an input image signal having an analog value into digital data and outputting the digital data to the motion vector detecting device.

19. The device of claim 15, wherein the target image storing section comprises one or more storage means.

20. The device of claim 16, wherein the target image storing section comprises one or more storage means.

21. The device of claim 15, wherein the reference image storing section comprises one or more storage means.

22. The device of claim 16, wherein the reference image storing section comprises one or more storage means.

23. An imaging system comprising:
the device of claim 16;
a sensor for converting image light into an image signal;
an optical system for bringing incident image light into focus on the sensor; and
an AD converter for converting the image signal into digital data and outputting digital data to the motion vector detecting device.

24. An imaging system comprising:
the device of claim 16; and
an AD converter for converting an input image signal having an analog value into digital data and outputting the digital data to the motion vector detecting device.
